(19) United States
(12) Patent Application Publication
(10) Pub. No.: US 2012/0151232 A1
(43) Pub. Date: Jun. 14, 2012

(54) CPU in Memory Cache Architecture

(76) Inventor: Russell Hamilton Fish, III, Dallas, TX (US)

(21) Appl. No.: 12/965,885

(22) Filed: Dec. 12, 2010

(51) Int. Cl. G06F 1/26

(52) U.S. Cl. 713/322; 711/125; 711/E12.02

(57) ABSTRACT

One exemplary CPU in memory cache architecture embodiment comprises a demultiplexer, and multiple partitioned caches for each processor, said caches comprising an I-cache dedicated to an instruction addressing register and an X-cache dedicated to a source addressing register; wherein each processor accesses an on-chip bus containing one RAM row for an associated cache; wherein all caches are operable to be filled or flushed in one RAS cycle, and all sense amps of the RAM row can be deselected by the demultiplexer to a duplicate corresponding bit of its associated cache. Several methods are also disclosed which evolved out of, and help enhance, the various embodiments. It is emphasized that this abstract is provided to enable a searcher to quickly ascertain the subject matter of the technical disclosure and is submitted with the understanding that it will not be used to interpret or limit the scope or meaning of the claims.

### TECHNICAL FIELD OF THE INVENTION

The present invention pertains in general to CPU in memory cache architectures and, more particularly, to a CPU in memory interdigitated cache architecture.

### BACKGROUND

Legacy computer architectures are implemented in microprocessors (the term “microprocessor” is also referred to equivalently herein as “processor”, “core” and central processing unit “CPU”) using complementary metal-oxide semiconductor (CMOS) transistors connected together on the die (the terms “die” and “chip” are used equivalently herein) with eight or more layers of metal interconnect. Memory, on the other hand, is typically manufactured on dies with three or more layers of metal interconnect. Caches are fast memory structures physically positioned between the computer's main memory and the central processing unit (CPU). Legacy cache systems (hereinafter “legacy cache(s)”) consume substantial amounts of power because of the enormous number of transistors required to implement them. The purpose of the caches is to shorten the effective memory access times for data access and instruction execution. In very high transaction volume environments involving competitive update and retrieval of data and instruction execution, experience demonstrates that frequently accessed instructions and data tend to be located physically close to other frequently accessed instructions and data in memory, and recently accessed instructions and data are also often accessed repeatedly. Caches take advantage of this spatial and temporal locality by maintaining redundant copies of likely to be accessed instructions and data in memory physically close to the CPU.

Legacy caches often define a “data cache” as distinct from an “instruction cache”. These caches intercept CPU memory requests, determine if the target data or instruction is present in cache, and respond with a cache read or write. The cache read or write will be many times faster than the read or write from or to external memory (i.e. such as an external DRAM, SRAM, FLASH MEMORY, and/or storage on tape or disk and the like, hereinafter collectively “external memory”). If the requested data or instruction is not present in the caches, a cache “miss” occurs, causing the required data or instruction to be transferred from external memory to cache. The effective memory access time of a single level cache is the “cache access time”×the “cache hit rate”+the “cache miss penalty”×the “cache miss rate”. Sometimes multiple levels of caches are used to reduce the effective memory access time even more. Each higher level cache is progressively larger in size and associated with a progressively greater cache “miss” penalty. A typical legacy microprocessor might have a Level1 cache access time of 1-3 CPU clock cycles, a Level2 access time of 8-20 clock cycles, and an off-chip access time of 80-200 clock cycles.

The acceleration mechanism of legacy instruction caches is based on the exploitation of spatial and temporal locality (i.e. caching the storage of loops and repetitively called functions like System Date, Login/Logout, etc.). The instructions within a loop are fetched from external memory once and stored in an instruction cache. The first execution pass through the loop will be the slowest due to the penalty of being first to fetch loop instructions from external memory. However, each subsequent pass through the loop will fetch the instructions directly from cache, which is much quicker.

Legacy cache logic translates memory addresses to cache addresses. Every external memory address must be compared to a table that lists the lines of memory locations already held in a cache. This comparison logic is often implemented as a Content Addressable Memory (CAM). Unlike standard computer random access memory (i.e. “RAM”, “DRAM”, SRAM, SDRAM, etc., referred to collectively herein as “RAM” or “DRAM” or “external memory” or “memory”, equivalently) in which the user supplies a memory address and the RAM returns the data word stored at that address, a CAM is designed such that the user supplies a data word and the CAM searches its entire memory to see if that data word is stored anywhere in it. If the data word is found, the CAM returns a list of one or more storage addresses where the word was found (and in some architectures, it also returns the data word itself, or other associated pieces of data). Therefore, a CAM is the hardware equivalent of what in software terms would be called an “associative array”. The comparison logic is complex and slow and grows in complexity and decreases in speed as the size of the cache increases. These “associative caches” tradeoff complexity and speed for an improved cache hit ratio.

Legacy operating systems (OS) implement virtual memory (VM) management to enable a small amount of physical memory to appear as a much larger amount of memory to programs/users. VM logic uses indirect addressing to translate VM addresses for a very large amount of memory to the addresses of a much smaller subset of physical memory locations. Indirection provides a way of accessing instructions, routines and objects while their physical location is constantly changing. The initial routine points to some memory address, and, using hardware and/or software, that memory address points to some other memory address. There can be multiple levels of indirection. For example, point to A, which points to B, which points to C. The physical memory locations consist of fixed size blocks of contiguous memory known as “page frames” or simply “frames”. When a program is selected for execution, the VM manager brings the program into virtual storage, divides it into pages of fixed block size (say four kilobytes “4K” for example), and then transfers the pages to main memory for execution. To the programmer/user, the entire program and data appear to occupy contiguous space in main memory at all times. Actually, however, not all pages of the program or data are necessarily in main memory simultaneously, and what pages are in main memory at any particular point in time, are not necessarily occupying contiguous space. The pieces of programs and data executing/accessed out of virtual storage, therefore, are moved back and forth between real and auxiliary storage by the VM manager as needed, before, during and after execution/access as follows:

(a) A block of main memory is a frame.

(b) A block of virtual storage is a page.

(c) A block of auxiliary storage is a slot.

A page, a frame, and a slot are all the same size. Active virtual storage pages reside in respective main memory frames. A virtual storage page that becomes inactive is moved to an auxiliary storage slot (in what is sometimes called a paging data set). The VM pages act as high level caches of likely accessed pages from the entire VM address space. The addressable memory page frames fill the page slots when the VM manager sends older, less frequently used pages to external auxiliary storage. Legacy VM management simplifies computer programming by assuming most of the responsibility for managing main memory and external storage.

Legacy VM management typically requires a comparison of VM addresses to physical addresses using a translation table. The translation table must be searched for each memory access and the virtual address translated to a physical address. A Translation Lookaside Buffer (TLB) is a small cache of the most recent VM accesses that can accelerate the comparison of virtual to physical addresses. The TLB is often implemented as a CAM, and as such, may be searched thousands of times faster than the serial search of a page table. Each instruction execution must incur overhead to look up each VM address.

Because caches constitute such a large proportion of the transistors and power consumption of legacy computers, tuning them is extremely important to the overall information technology budget for most organizations. That “tuning” can come from improved hardware or software, or both. “Software tuning” typically comes in the form of placing frequently accessed programs, data structures and data into caches defined by database management systems (DBMS) software like DB2, Oracle, Microsoft SQL Server and MS/Access. DBMS implemented cache objects enhance application program execution performance and database throughput by storing important data structures like indexes and frequently executed instructions like Structured Query Language (SQL) routines that perform common system or database functions (i.e. “DATE” or “LOGIN/LOGOUT”).

For general-purpose processors, much of the motivation for using multi-core processors comes from greatly diminished potential gains in processor performance from increasing the operating frequency (i.e. clock cycles per second). This is due to three primary factors:
1. The memory wall; the increasing gap between processor and memory speeds. This effect pushes cache sizes larger in order to mask the latency of memory. This helps only to the extent that memory bandwidth is not the bottleneck in performance.
2. The instruction-level parallelism (ILP) wall; the increasing difficulty of finding enough parallelism in a single instructions stream to keep a high-performance single-core processor busy.
3. The power wall; the linear relationship of increasing power with increase of operating frequency. This increase can be mitigated by “shrinking” the processor by using smaller traces for the same logic. The power wall poses manufacturing, system, design and deployment problems that have not been justified in the face of the diminished gains in performance due to the memory wall and ILP wall.

In order to continue delivering regular performance improvements for general purpose processors, manufacturers such as Intel and AMD have turned to multi-core designs, sacrificing lower manufacturing-costs for higher performance in some applications and systems. Multi-core architectures are being developed, but so are the alternatives. For example, an especially strong contender for established markets is the further integration of peripheral functions into the chip.

The proximity of multiple CPU cores on the same die allows the cache coherency circuitry to operate at a much higher clock-rate than is possible if the signals have to travel off-chip. Combining equivalent CPUs on a single die significantly improves the performance of cache and bus snoop operations. Because signals between different CPUs travel shorter distances, those signals degrade less. These “higher-quality” signals allow more data to be sent more reliably in a given time period, because individual signals can be shorter and do not need to be repeated as often. The largest boost in performance occurs with CPU-intensive processes, like antivirus scans, ripping/burning media (requiring file conversion), or searching for folders. For example, if an automatic virus-scan runs while a movie is being watched, the application running the movie is far less likely to be starved of processor power, because the antivirus program will be assigned to a different processor core than the one running the movie. Multi-core processors are ideal for DBMSs and OSs, because they allow many users to connect to a site simultaneously and have independent processor execution. As a result, web servers and application servers can achieve much better throughput.

Legacy computers have on-chip caches and busses that route instructions and data back and forth from the caches to the CPU. These busses are often single ended with rail-to-rail voltage swings. Some legacy computers use differential signaling (DS) to increase speed. For example, low voltage bussing was used to increase speed by companies like RAMBUS Incorporated, a California company that introduced fully differential high speed memory access for communications between CPU and memory chips. The RAMBUS equipped memory chips were very fast but consumed much more power as compared to double data rate (DDR) memories like SRAM or SDRAM. As another example, Emitter Coupled Logic (ECL) achieved high speed bussing by using single ended, low voltage signaling. ECL buses operated at 0.8 volts when the rest of the industry operated at 5 volts and higher. However, the disadvantage of ECL, like RAMBUS and most other low voltage signaling systems, is that they consume too much power, even when they are not switching.

Another problem with legacy cache systems is that memory bit line pitch is kept very small in order to pack the largest number of memory bits on the smallest die. “Design Rules” are the physical parameters that define various elements of devices manufactured on a die. Memory manufacturers define different rules for different areas of the die. For example, the most size critical area of memory is the memory cell. The Design Rules for the memory cell might be called “Core Rules”. The next most critical area often includes elements such as bit line sense amps (BLSA, hereinafter “sense amps”). The Design Rules for this area might be called “Array Rules”. Everything else on the memory die, including decoders, drivers, and I/O are managed by what might be called “Peripheral Rules”. Core Rules are the densest, Array Rules next densest, and peripheral Rules least dense. For example, the minimum physical geometric space required to implement Core Rules might be 110 nm, while the minimum geometry for Peripheral Rules might require 180 nm. Line pitch is determined by Core Rules. Most logic used to implement CPU in memory processors is determined by Peripheral Rules. As a consequence, there is very limited space available for cache bits and logic. Sense amps are very small and very fast, but they do not have very much drive capability, either.

Still another problem with legacy cache systems is the processing overhead associated with using sense amps directly as caches, because the sense amp contents are changed by refresh operations. While this can work on some memories, it presents problems with DRAMs (dynamic random access memories). A DRAM requires that every bit of its memory array be read and rewritten once every certain period of time in order to refresh the charge on the bit storage capacitors. If the sense amps are used directly as caches, during each refresh time, the cache contents of the sense amps must be written back to the DRAM row that they are caching. The DRAM row to be refreshed then must be read and written back. Finally, the DRAM row previously being held by the cache must be read back into the sense amp cache.

### SUMMARY

What is needed to overcome the aforementioned limitations and disadvantages of the prior art, is a new CPU in memory cache architecture which solves many of the challenges of implementing VM management on single-core (hereinafter, “CIM”) and multi-core (hereinafter, “CIMM”) CPU in memory processors. More particularly, a cache architecture is disclosed for a computer system having at least one processor and merged main memory manufactured on a monolithic memory die, comprising a multiplexer, a demultiplexer, and local caches for each said processor, said local caches comprising a DMA-cache dedicated to at least one DMA channel, an I-cache dedicated to an instruction addressing register, an X-cache dedicated to a source addressing register, and a Y-cache dedicated to a destination addressing register; wherein each said processor accesses at least one on-chip internal bus containing one RAM row that can be the same size as an associated local cache; wherein said local caches are operable to be filled or flushed in one row address strobe (RAS) cycle, and all sense amps of said RAM row can be selected by said multiplexer and deselected by said demultiplexer to a duplicate corresponding bit of the associated said local cache which can be used for RAM refresh. This new cache architecture employs a new method for optimizing the very limited physical space available for cache bit logic on a CIM chip. Memory available for cache bit logic is increased through cache partitioning into multiple separate, albeit smaller, caches that can each be accessed and updated simultaneously. Another aspect of the invention employs an analog Least Frequently Used (LFU) detector for managing VM through cache page “misses”. In another aspect, the VM manager can parallelize cache page “misses” with other CPU operations. In another aspect, low voltage differential signaling dramatically reduces power consumption for long busses. In still another aspect, a new boot read only memory (ROM) paired with an instruction cache is provided that simplifies the initialization of local caches during “Initial Program Load” of the OS. In yet still another aspect, the invention comprises a method for decoding local memory, virtual memory and off-chip external memory by a CIM or CIMM VM manager.

In another aspect, the invention comprises a cache architecture for a computer system having at least one processor, comprising a demultiplexer, and at least two local caches for each said processor, said local caches comprising an I-cache dedicated to an instruction addressing register and an X-cache dedicated to a source addressing register; wherein each said processor accesses at least one on-chip internal bus containing one RAM row for an associated said local cache; wherein said local caches are operable to be filled or flushed in one RAS cycle, and all sense amps of said RAM row can be deselected by said demultiplexer to a duplicate corresponding bit of the associated said local cache.

In another aspect, the invention's local caches further comprise a DMA-cache dedicated to at least one DMA channel, and in various other embodiments these local caches may further comprise an S-cache dedicated to a stack work register in every possible combination with a possible Y-cache dedicated to a destination addressing register and an S-cache dedicated to a stack work register.

In another aspect, the invention may further comprise at least one LFU detector for each processor comprising on-chip capacitors and operational amplifiers configured as a series of integrators and comparators which implement Boolean logic to continuously identify a least frequently used cache page through reading the IO address of the LFU associated with that cache page.

In another aspect, the invention may further comprise a boot ROM paired with each local cache to simplify CIM cache initialization during a reboot operation.

In another aspect, the invention may further comprise a multiplexer for each processor to select sense amps of a RAM row.

In another aspect, the invention may further comprise each processor having access to at least one on-chip internal bus using low voltage differential signaling.

In another aspect, the invention comprises a method of connecting a processor within the RAM of a monolithic memory chip, comprising the steps necessary to allow selection of any bit of said RAM to a duplicate bit maintained in a plurality of caches, the steps comprising:
(a) logically grouping memory bits into groups of four;
(b) sending all four bit lines from said RAM to a multiplexer input;
(c) selecting one of the four bit lines to the multiplexer output by switching one of four switches controlled by four possible states of address lines;
(d) connecting one of said plurality of caches to the multiplexer output by using demultiplexer switches provided by instruction decoding logic.

In another aspect, the invention comprises a method for managing VM of a CPU through cache page misses, comprising the steps of:

(a) while said CPU processes at least one dedicated cache addressing register, said CPU inspects the contents of said register's high order bits; and

(b) when the contents of said bits change, said CPU returns a page fault interrupt to a VM manager to replace the contents of said cache page with a new page of VM corresponding to the page address contents of said register, if the page address contents of said register is not found in a CAM TLB associated with said CPU; otherwise

(c) said CPU determines a real address using said CAM TLB.

In another aspect, the method for managing VM of the present invention further comprises the step of:

(d) determining the least frequently cached page currently in said CAM TLB to receive the contents of said new page of VM, if the page address contents of said register is not found in a CAM TLB associated with said CPU.

In another aspect, the method for managing VM of the present invention further comprises the step of:

(e) recording a page access in an LFU detector; said step of determining further comprising determining the least frequently cached page currently in the CAM TLB using said LFU detector.

In another aspect, the invention comprises a method to parallelize cache misses with other CPU operations, comprising the steps of:

(a) until cache miss processing for a first cache is resolved, processing the contents of at least a second cache if no cache miss occurs while accessing the second cache; and

(b) processing the contents of the first cache.

In another aspect, the invention comprises a method of reducing power consumption in digital buses on a monolithic chip, comprising the steps of:
(a) equalizing and pre-charging a set of differential bits on at least one bus driver of said digital buses;
(b) equalizing a receiver;
(c) maintaining said bits on said at least one bus driver for at least the slowest device propagation delay time of said digital buses;
(d) turning off said at least one bus driver;
(e) turning on the receiver; and
(f) reading said bits by the receiver.

In another aspect, the invention comprises a method to lower power consumed by cache buses, comprising the following steps:
(a) equalize pairs of differential signals and pre-charge said signals to Vcc;
(b) pre-charge and equalize a differential receiver;
(c) connect a transmitter to at least one differential signal line of at least one cross-coupled inverted and discharge it for a period of time exceeding the cross-coupled inverter device propagation delay time;
(d) connect the differential receiver to said at least one differential signal line; and
(e) enable the differential receiver allowing said at least one cross-coupled inverter to reach full Vcc swing while biased by said at least one differential line.

In another aspect, the invention comprises a method of booting CPU in memory architecture using a bootload linear ROM, comprising the following steps:

(a) detect a Power Valid condition by said bootload ROM;

(b) hold all CPUs in Reset condition with execution halted;

(c) transfer said bootload ROM contents to at least one cache of a first CPU;

(d) set a register dedicated to said at least one cache of said first CPU to binary zeroes; and

(e) enable a System clock of said first CPU to begin executing from said at least one cache.

In another aspect, the invention comprises a method for decoding local memory, virtual memory and off-chip external memory by a CIM VM manager, comprising the steps of:

(a) while a CPU processes at least one dedicated cache addressing register, if said CPU determines that at least one high order bit of said register has changed; then

(b) when the contents of said at least one high order bit is nonzero, said VM manager transfers a page addressed by said register from said external memory to said cache using an external memory bus; otherwise

(c) said VM manager transfers said page from said local memory to said cache.

In another aspect, the method for decoding local memory by a CIM VM manager of the present invention further comprises the step of:

wherein said at least one high order bit of said register only changes during processing of a STORACC instruction to any addressing register, a pre-decrement instruction, and a post-increment instruction, said CPU determines step further comprising determination by instruction type.

In another aspect, the invention comprises a method for decoding local memory, virtual memory and off-chip external memory by a CIMM VM manager, comprising the steps of:

(a) while a CPU processes at least one dedicated cache addressing register, if said CPU determines that at least one high order bit of said register has changed; then

(b) when the contents of said at least one high order bit is nonzero, said VM manager transfers a page addressed by said register from said external memory to said cache using an external memory bus and an interprocessor; otherwise

(c) if said CPU detects that said register is not associated with said cache, said VM manager transfers said page from a remote memory bank to said cache using said interprocessor bus; otherwise

(c) said VM manager transfers said page from said local memory to said cache.

In another aspect, the method for decoding local memory by a CIMM VM manager of the present invention further comprises the step of:

wherein said at least one high order bit of said register only changes during processing of a STORACC instruction to any addressing register, a pre-decrement instruction, and a post-increment instruction, said CPU determines step further comprising determination by instruction type.

### BRIEF DESCRIPTION OF THE DRAWINGS

FIG. 1 depicts an exemplary Prior Art Legacy Cache Architecture.

FIG. 2 shows an exemplary Prior Art CIMM Die having two CIMM CPUs.

FIG. 3 demonstrates Prior Art Legacy Data and Instruction Caches.

FIG. 4 shows Prior Art Pairing of Cache with Addressing Registers.

FIGS. 5A-D demonstrate embodiments of a Basic CIM Cache architecture.

FIGS. 5E-H demonstrate embodiments of an Improved CIM Cache architecture.

FIGS. 6A-D demonstrate embodiments of a Basic CIMM Cache architecture.

FIGS. 6E-H demonstrate embodiments of an Improved CIMM Cache architecture.

FIG. 7A shows how multiple caches are selected according to one embodiment.

FIG. 7B is a memory map of 4 CIMM CPUs integrated into a 64 Mbit DRAM.

FIG. 7C shows exemplary memory logic for managing a requesting CPU and a responding memory bank as they communicate on an interprocessor bus.

FIG. 7D shows how decoding three types of memory is performed according to one embodiment.

FIG. 8A shows where LFU Detectors (100) physically exist in one embodiment of a CIMM Cache.

FIG. 8B depicts VM Management by Cache Page “Misses” using a “LFU IO port”.

FIG. 8C depicts the physical construction of a LFU Detector (100).

FIG. 8D shows exemplary LFU Decision Logic.

FIG. 8E shows an exemplary LFU Truth Table.

FIG. 9 describes Parallelizing Cache Page “Misses” with other CPU Operations.

FIG. 10A is an electrical diagram showing CIMM Cache Power Savings Using Differential Signaling.

FIG. 10B is an electrical diagram showing CIMM Cache Power Savings Using Differential Signaling by Creating Vdiff.

FIG. 10C depicts exemplary CIMM Cache Low Voltage Differential Signaling of one embodiment.

FIG. 11A depicts an exemplary CIMM Cache BootROM Configuration of one embodiment.

FIG. 11B shows one contemplated exemplary CIMM Cache Boot Loader Operation.

### DETAIL DESCRIPTION OF CERTAIN EMBODIMENTS

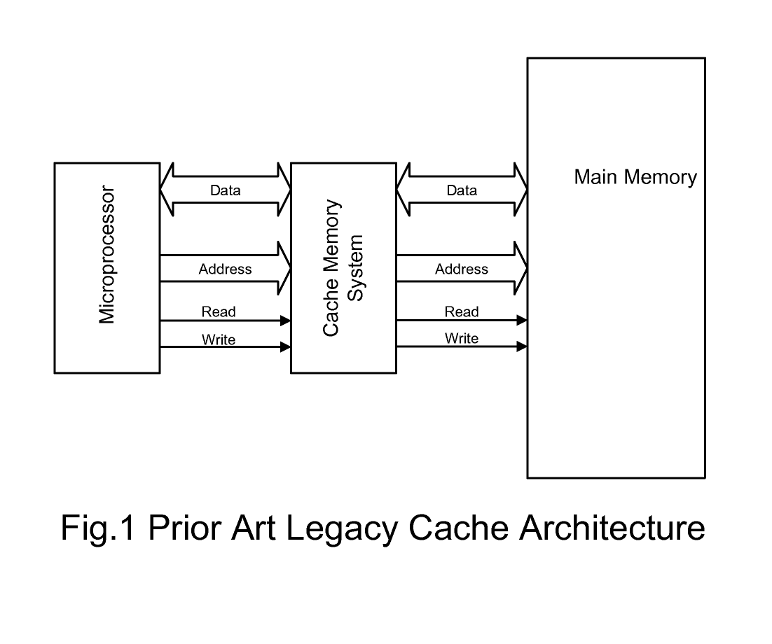

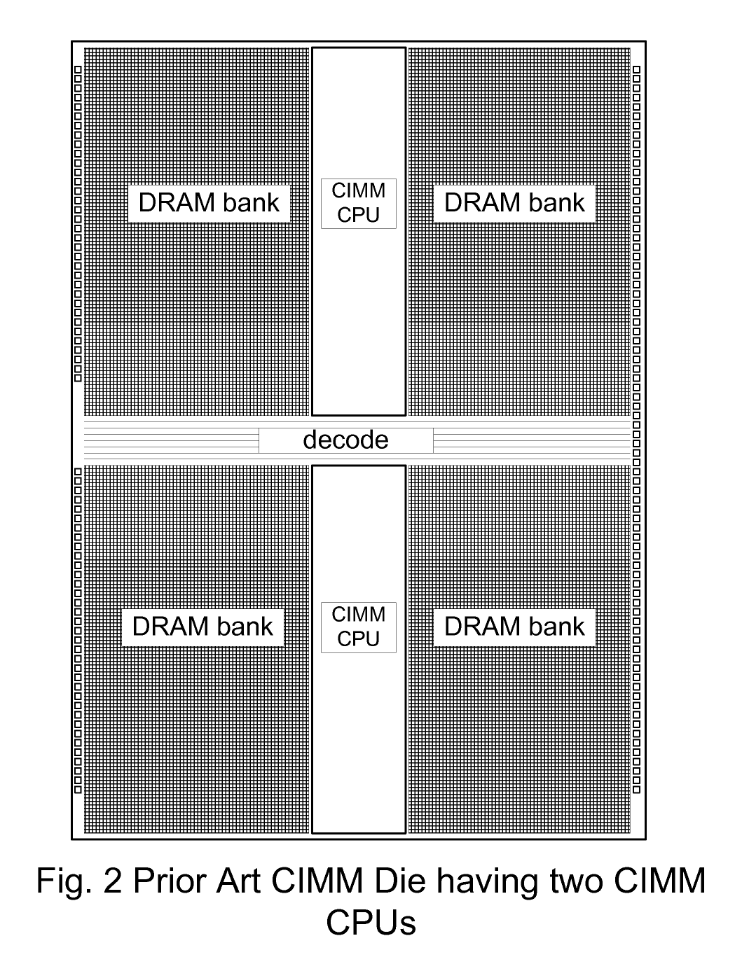

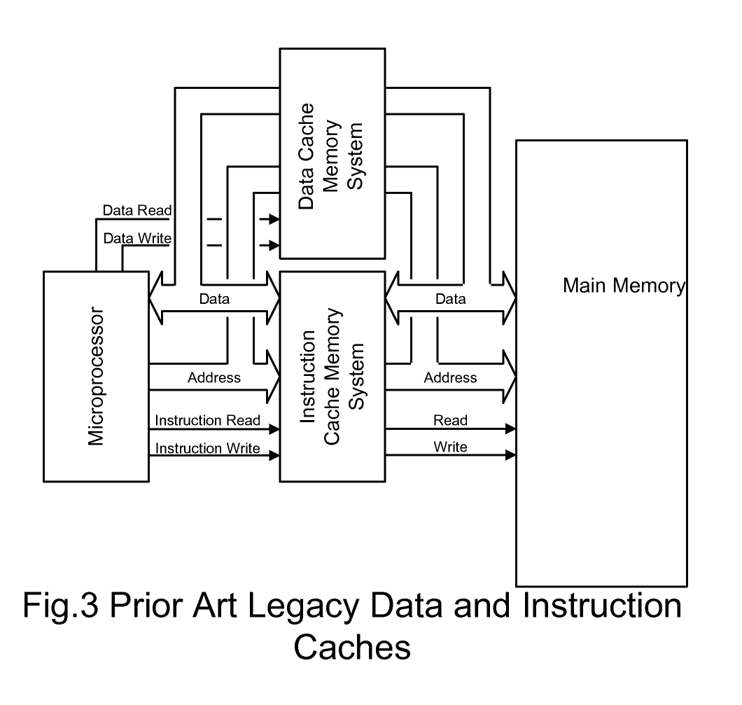

FIG. 1 depicts an exemplary legacy cache architecture, and FIG. 3 distinguishes legacy data caches from legacy instruction caches. A prior art CIMM, such as that depicted in FIG. 2, substantially mitigates the memory bus and power dissipation problems of legacy computer architectures by placing the CPU physically adjacent to main memory on the silicon die. The proximity of the CPU to main memory presents an opportunity for CIMM Caches to associate closely with the main memory bit lines, such as those found in DRAM, SRAM, and Flash devices. The advantages of this interdigitation between cache and memory bit lines include:
1. Very short physical space for routing between cache and memory, thereby reducing access time and power consumption;
2. Significantly simplified cache architecture and related control logic; and
3. Capability to load entire cache during a single RAS cycle.

### CIMM Cache Accelerates Straight-Line Code

The CIMM Cache Architecture accordingly can accelerate loops that fit within its caches, but unlike legacy instruction cache systems, CIMM Caches will accelerate even single-use straight-line code by parallel cache loading during a single RAS cycle. One contemplated CIMM Cache embodiment comprises the capability to fill a 512 instruction cache in 25 clock cycles. Since each instruction fetch from cache requires a single cycle, even when executing straight-line code, the effective cache read time is: 1 cycle+25 cycles/512=1.05 cycles.

One embodiment of CIMM Cache comprises placing main memory and a plurality of caches physically adjacent one another on the memory die and connected by very wide busses, thus enabling:
1. Pairing at least one cache with each CPU addressing register;
2. Managing VM by cache page; and
3. Parallelizing cache “miss” recovery with other CPU operations.

### Pairing Cache with Addressing Registers

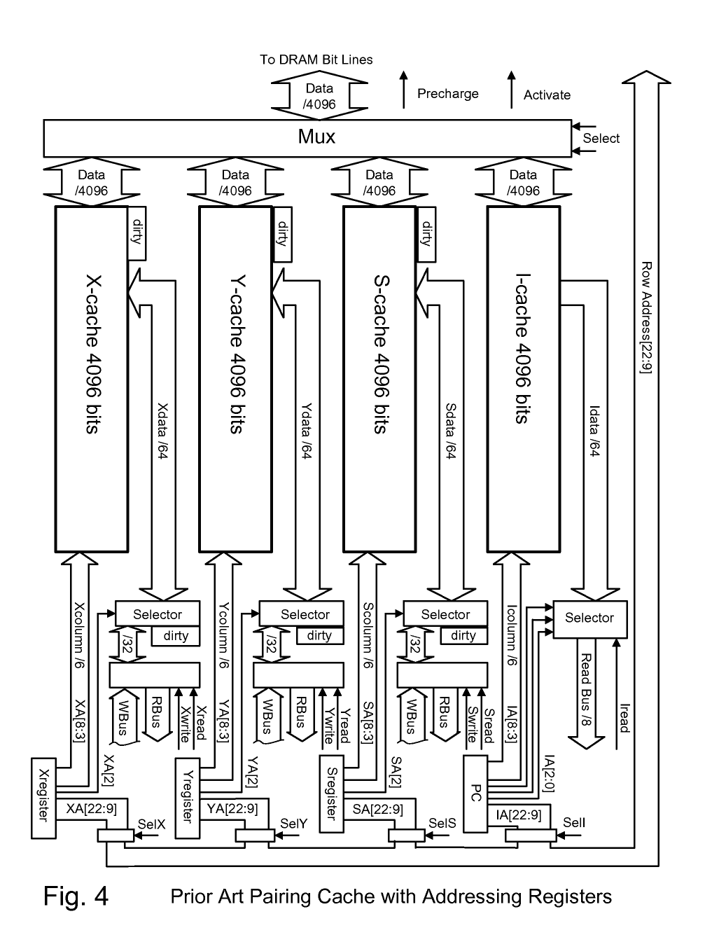

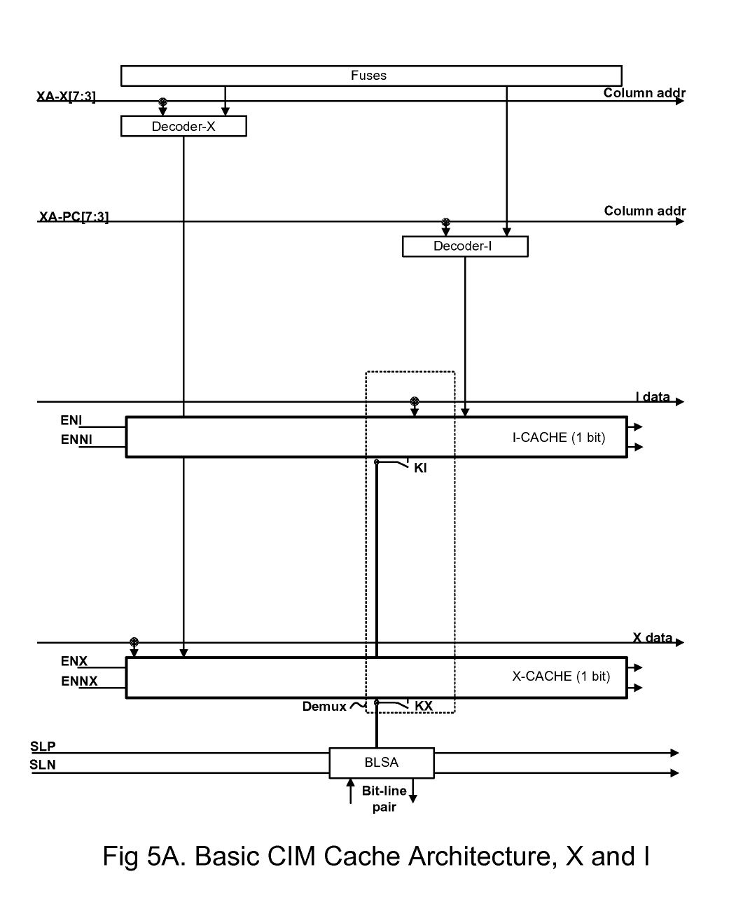

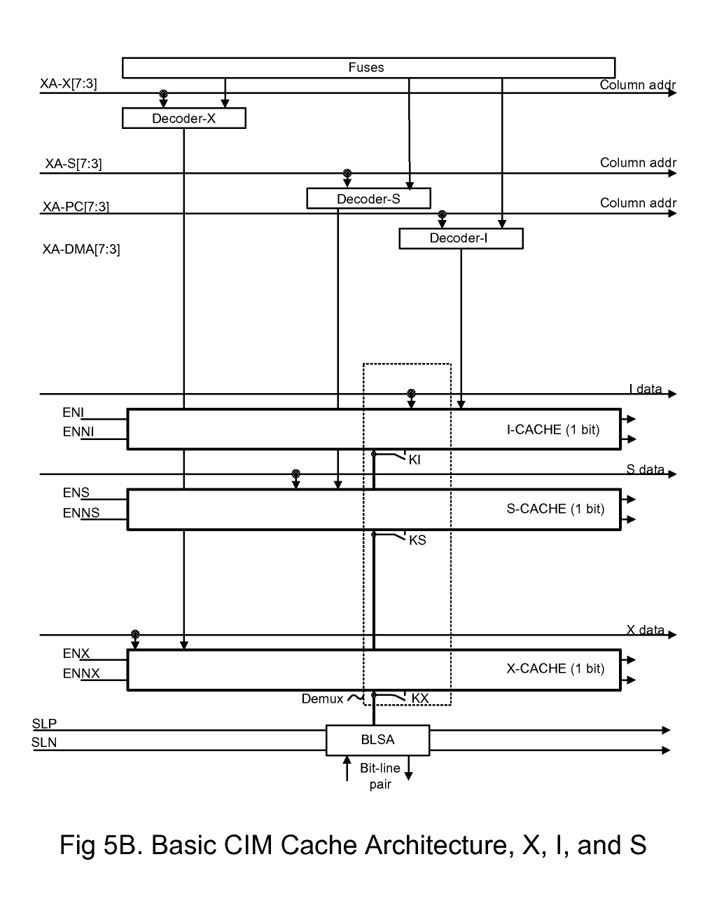

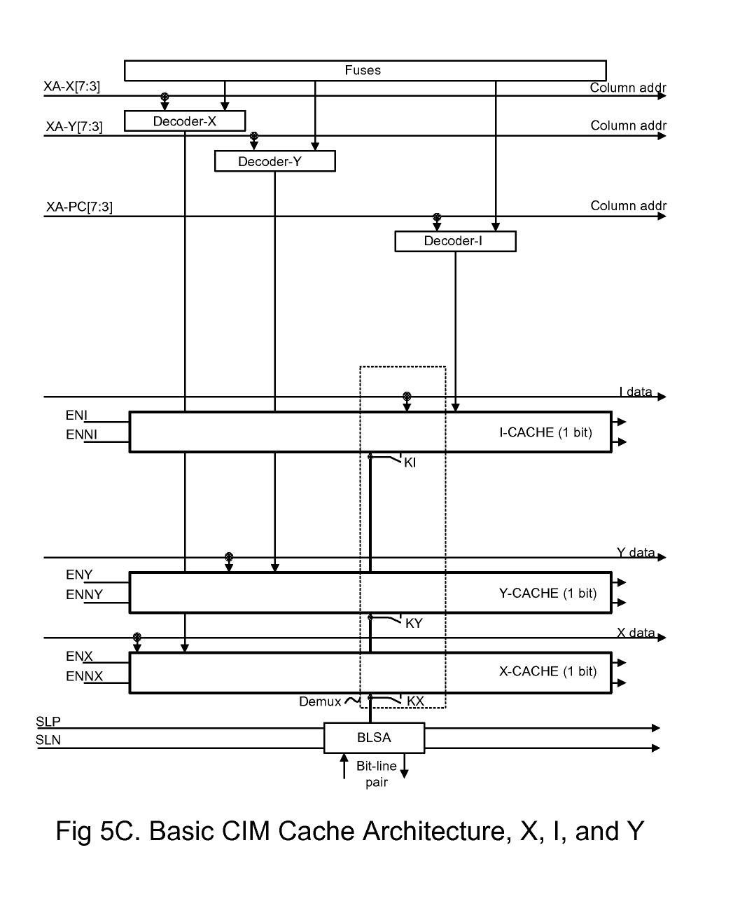

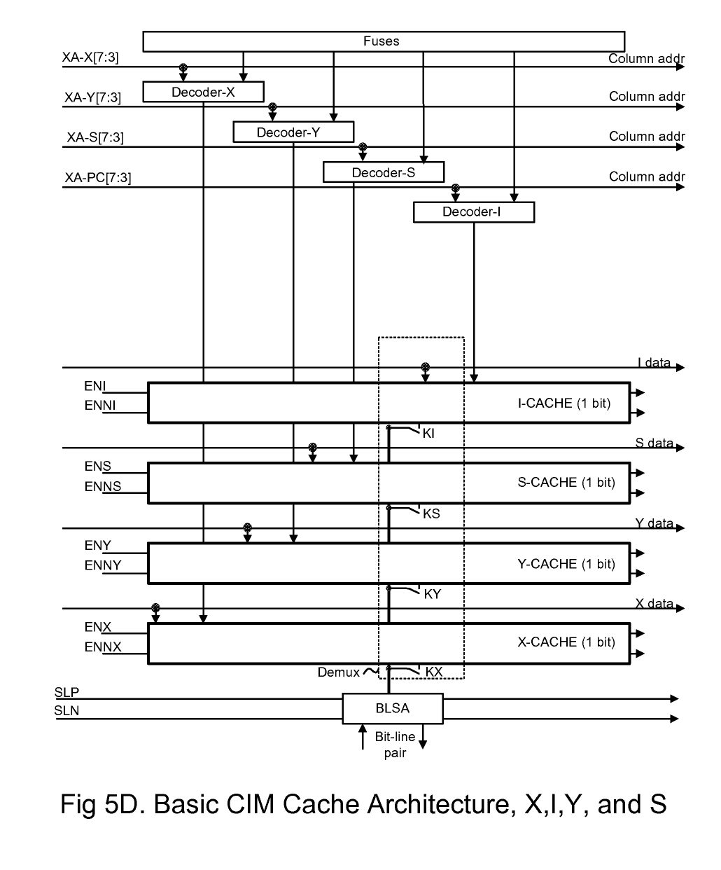

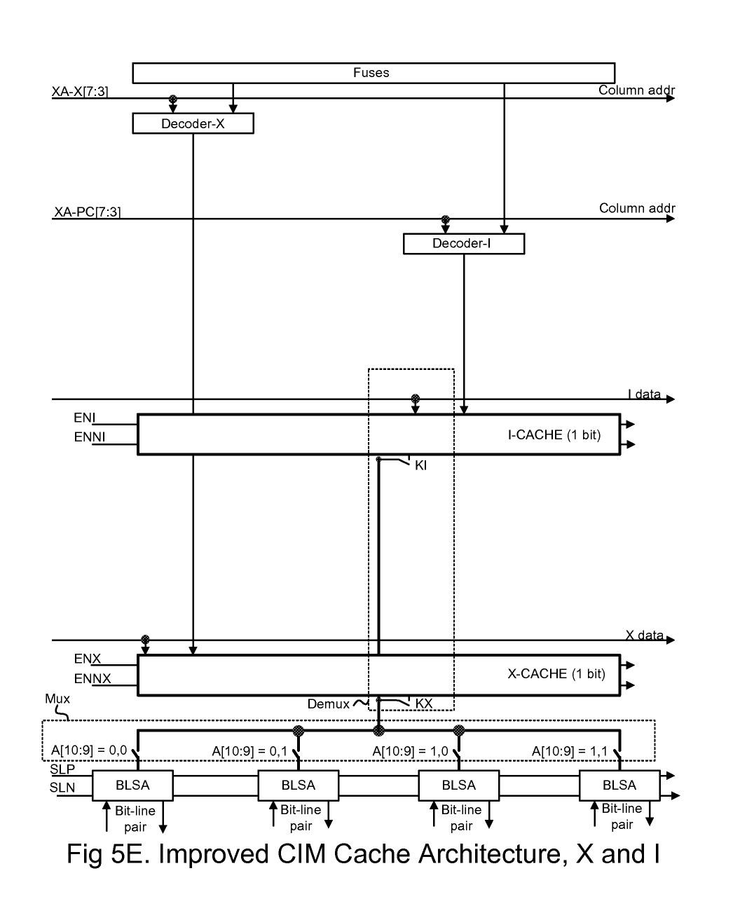

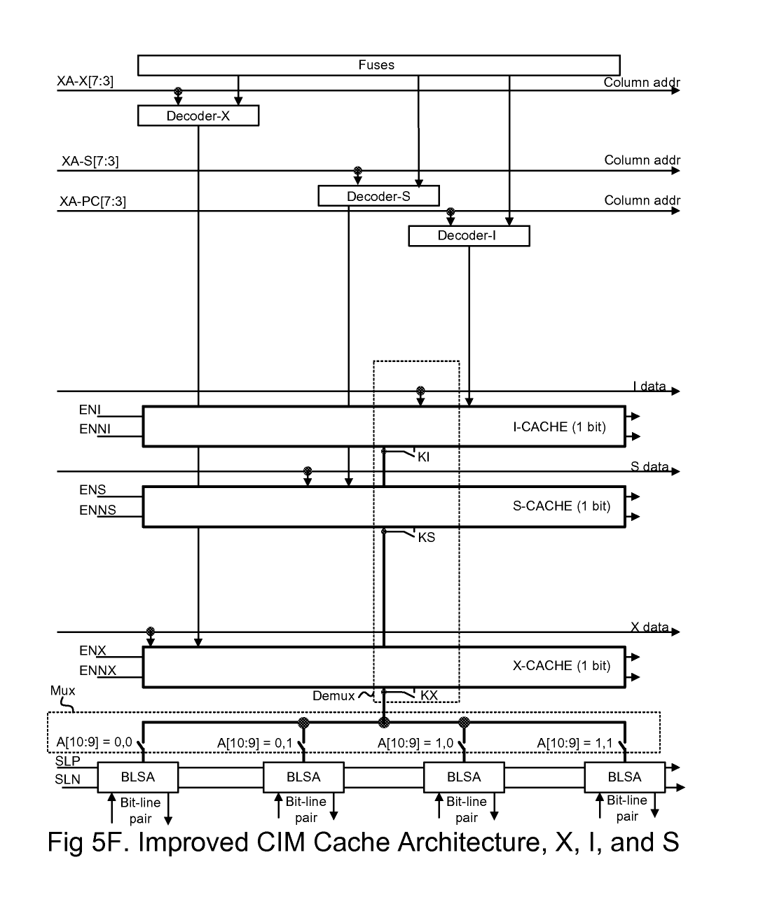

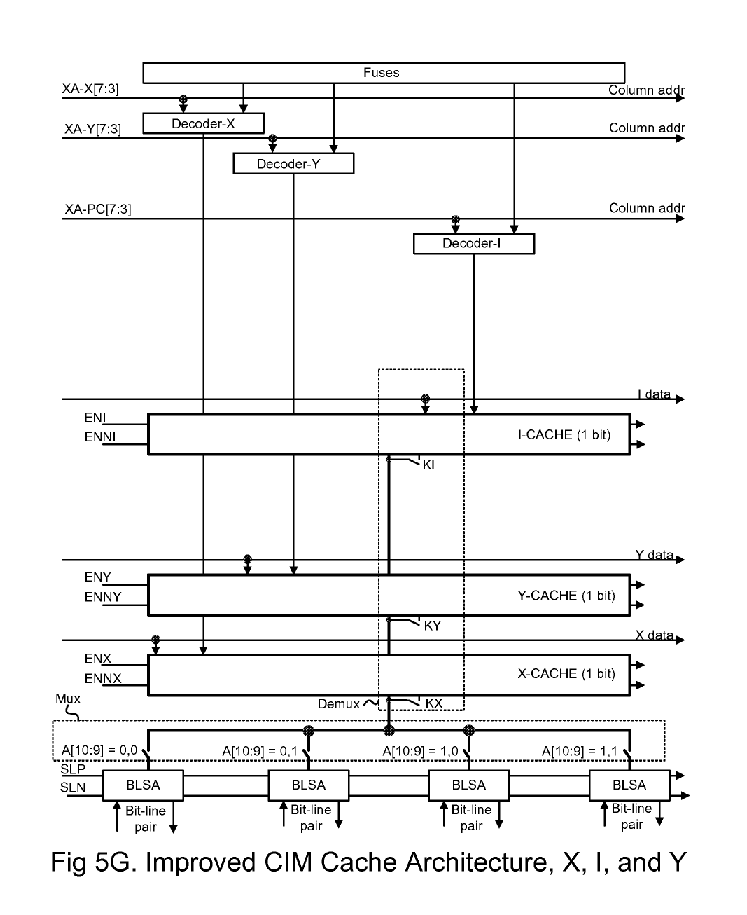

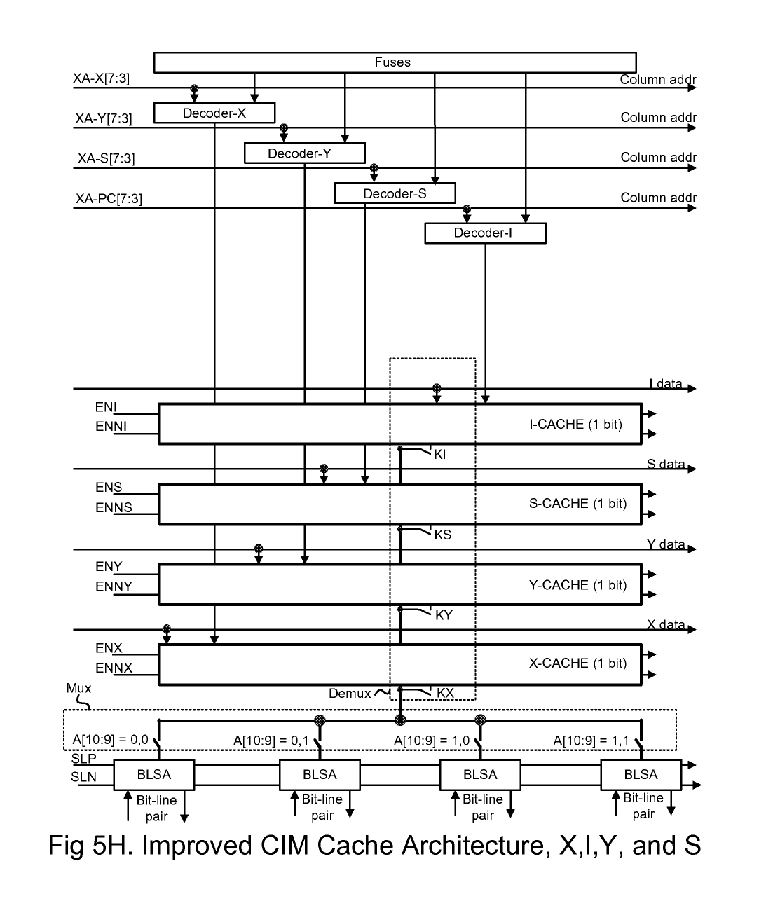

Pairing caches with addressing registers is not new. FIG. 4 shows one prior art example, comprising four addressing registers: X, Y, S (stack work register), and PC (same as an instruction register). Each address register in FIG. 4 is associated with a 512 byte cache. As in legacy cache architectures, the CIMM Caches only access memory through a plurality of dedicated address registers, where each address register is associated with a different cache. By associating memory access to address registers, cache management, VM management, and CPU memory access logic are significantly simplified. Unlike legacy cache architectures, however, the bits of each CIMM Cache are aligned with the bit lines of RAM, such as a dynamic RAM or DRAM, creating interdigitated caches. Addresses for the contents of each cache are the least significant (i.e. right-most in positional notation) 9 bits of the associated address register. One advantage of this interdigitation between cache bit lines and memory is the speed and simplicity of determining a cache “miss”. Unlike legacy cache architectures, CIMM Caches evaluate a “miss” only when the most significant bits of an address register change, and an address register can only be changed in one of two ways, as follows:

1. A STOREACC to Address Register. For example: STOREACC, X,

2. Carry/Borrow from the 9 least significant bits of the address register. For example: STOREACC, (X+)

CIMM Cache achieves a hit rate in excess of 99% for most instruction streams. This means that fewer than 1 instruction out of 100 experiences delay while performing “miss” evaluation.

### CIMM Cache Significantly Simplifies Cache Logic

CIMM Cache may be thought of as a very long single line cache. An entire cache can be loaded in a single DRAM RAS cycle, so the cache “miss” penalty is significantly reduced as compared to legacy cache systems which require cache loading over a narrow 32 or 64-bit bus. The “miss” rate of such a short cache line is unacceptably high. Using a long single cache line, CIMM Cache requires only a single address comparison. Legacy cache systems do not use a long single cache line, because this would multiply the cache “miss” penalty many times as compared to that of using the conventional short cache line required of their cache architecture.

### CIMM Cache Solution to Narrow Bit Line Pitch

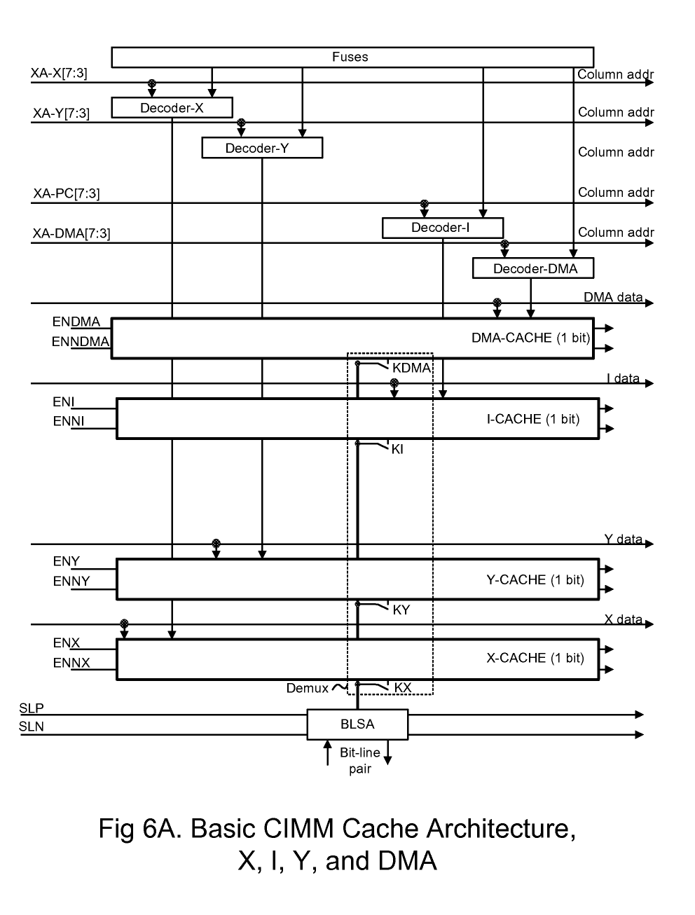

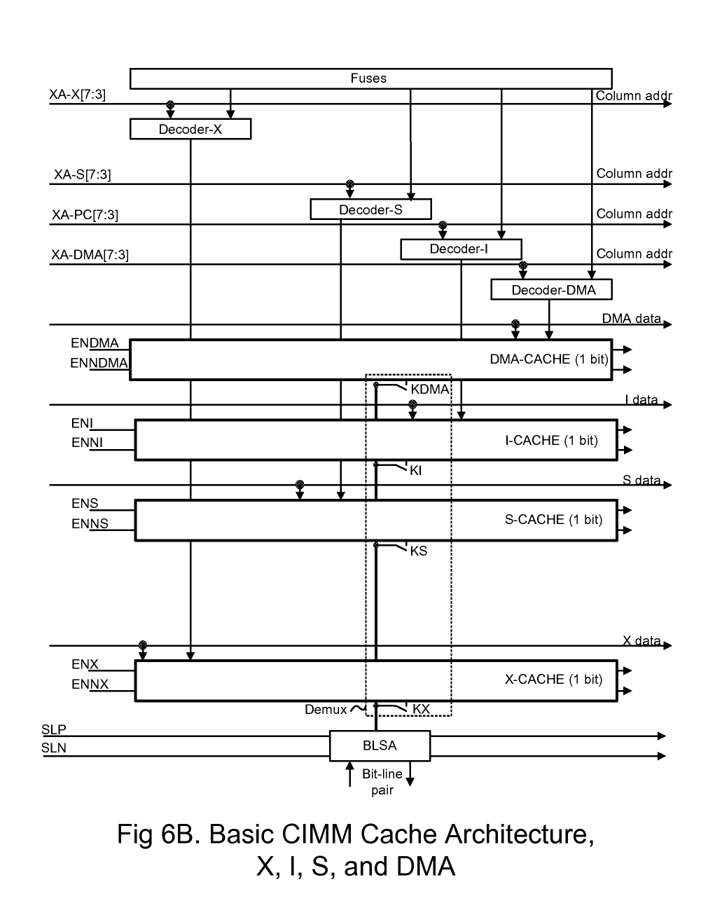

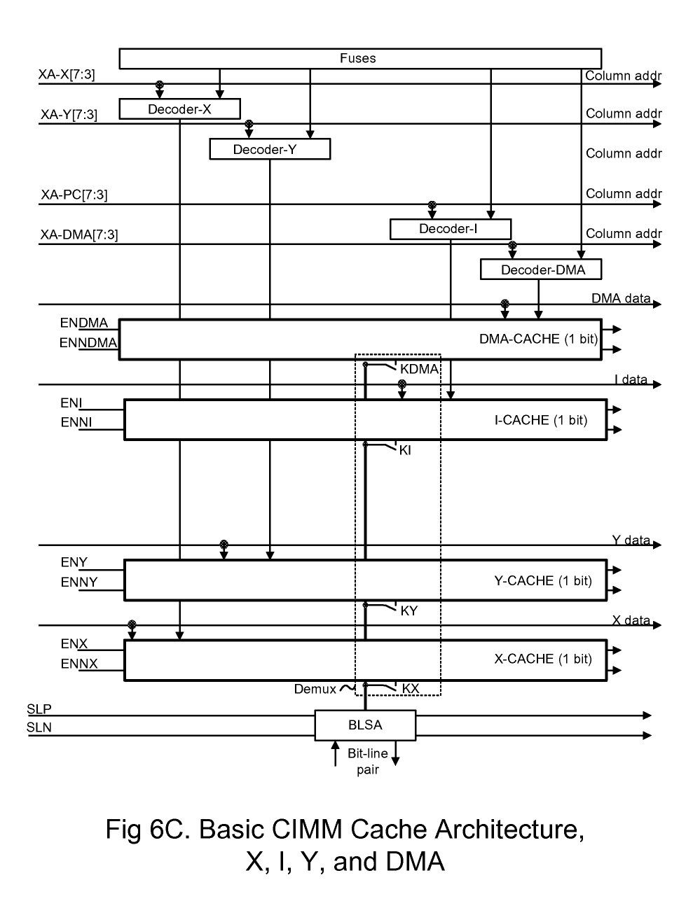

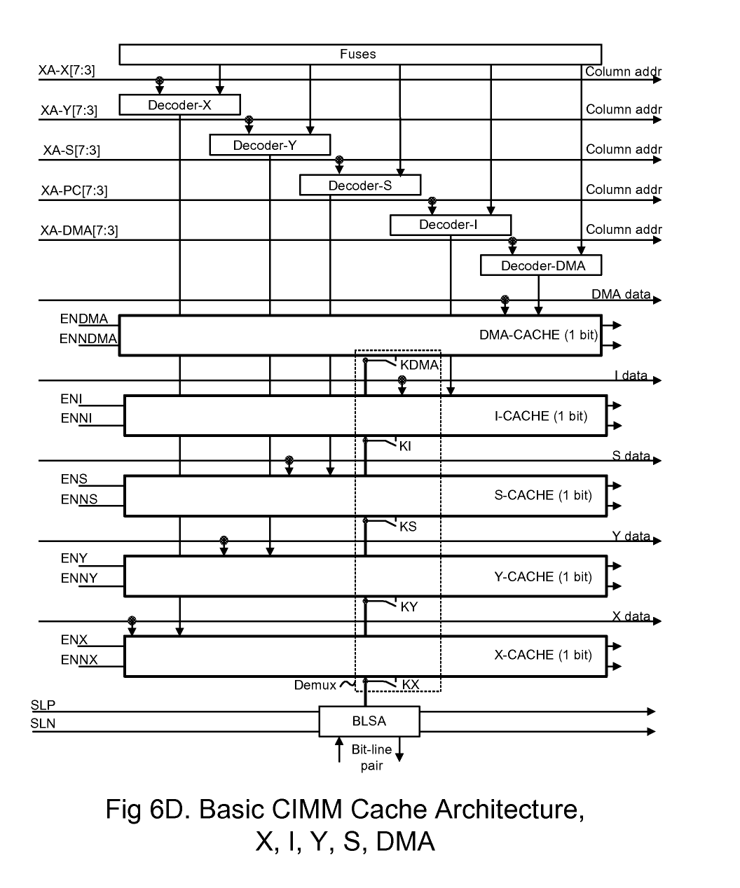

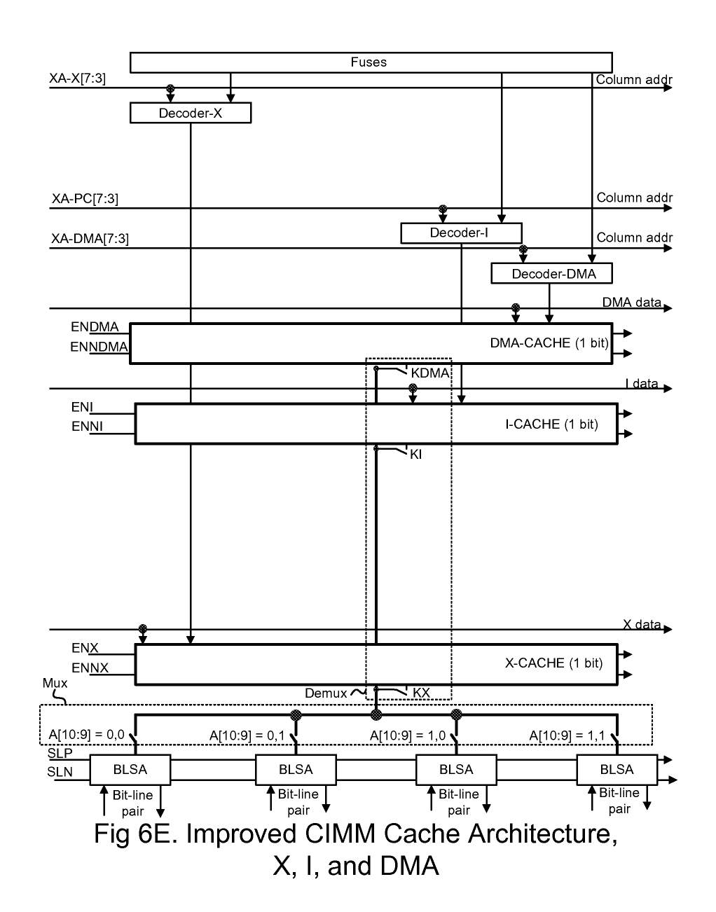

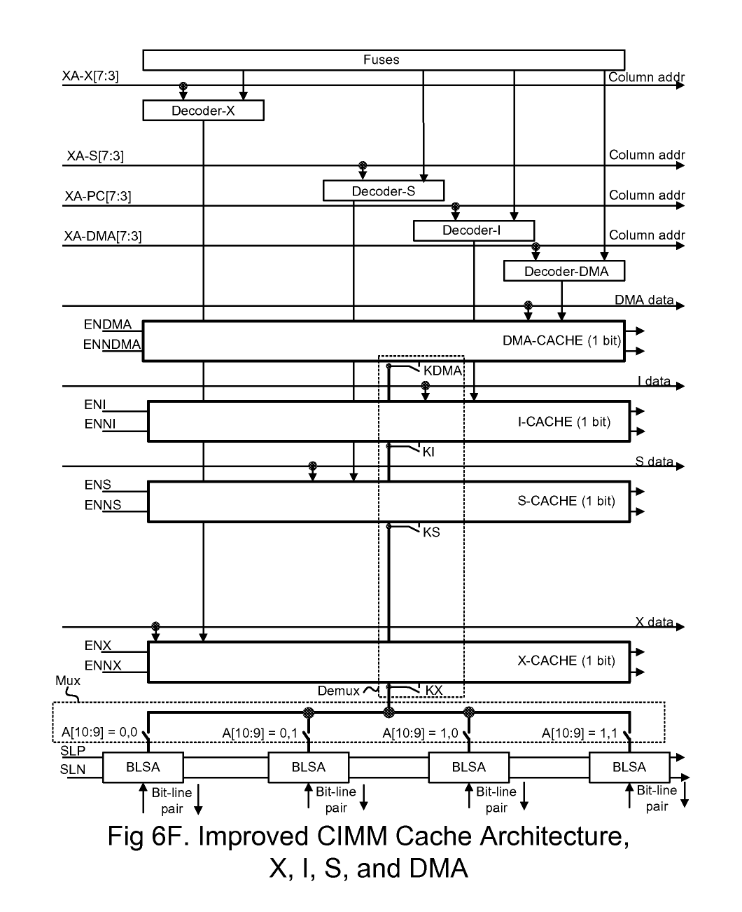

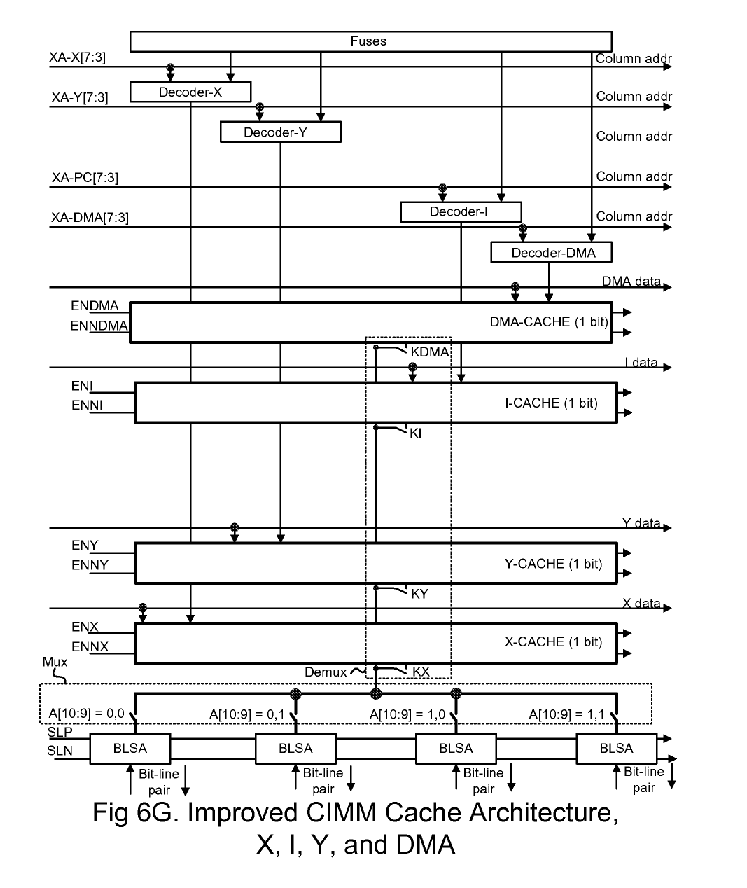

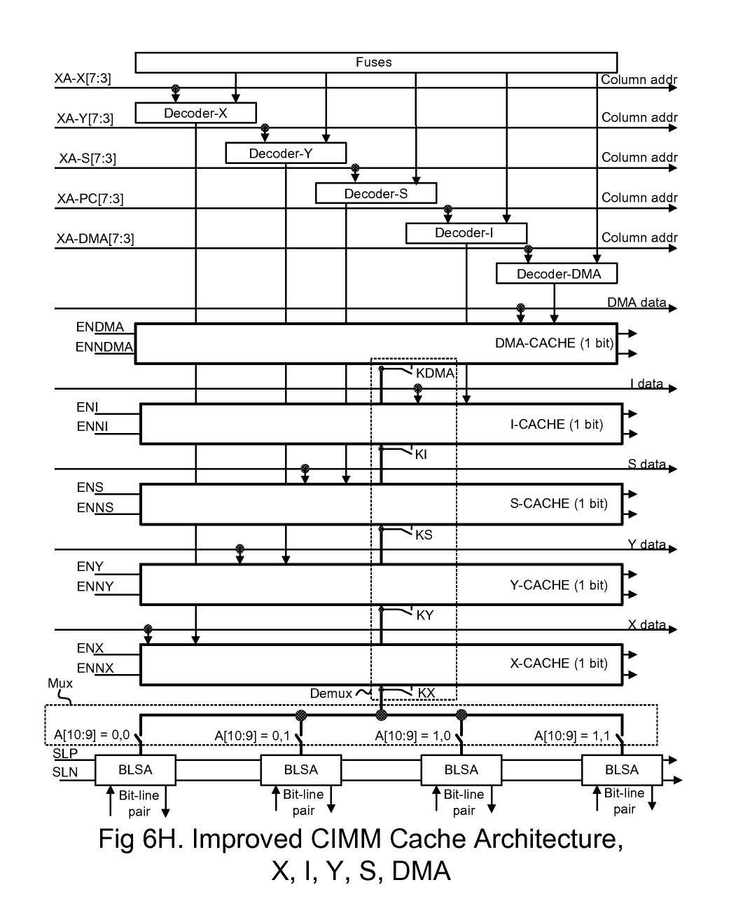

One contemplated CIMM Cache embodiment solves many of the problems that are presented by CIMM narrow bit line pitch between CPU and cache. FIG. 6H shows 4 bits of a CIMM Cache embodiment and the interaction of the 3 levels of Design Rules previously described. The left side of FIG. 6H includes bit lines that attach to memory cells. These are implemented using Core Rules. Moving to the right, the next section includes 5 caches designated as DMA-cache, X-cache, Y-cache, S-cache, and I-cache. These are implemented using Array Rules. The right side of the drawing includes a latch, bus driver, address decode, and fuse. These are implemented using Peripheral Rules. CIMM Caches solve the following problems of prior art cache architectures:

### 1. Sense Amp Contents Changed by Refresh.

FIG. 6H shows DRAM sense amps being mirrored by a DMA-cache, an X-cache, a Y-cache, an S-cache, and an I-cache. In this manner, the caches are isolated from the DRAM refresh and CPU performance is enhanced.

### 2. Limited Space for Cache Bits.

Sense amps are actually latching devices. In FIG. 6H, CIMM Caches are shown to duplicate the sense amp logic and design rules for DMA-cache, X-cache, Y-cache, S-cache, and I-cache. As a result, one cache bit can fit in the bit line pitch of the memory. One bit of each of the 5 caches is laid out in the same space as 4 sense amps. Four pass transistors select any one of 4 sense amp bits to a common but. Four additional pass transistors select the but bit to any one of the 5 caches. In this way any memory bit can be stored to any one of the 5 interdigitated caches shown in FIG. 6H.

### Matching Cache to DRAM Using Mux/Demux

Prior art CIMMs such as those depicted in FIG. 2 match the DRAM bank bits to the cache bits in an associated CPU. The advantage of this arrangement is a significant increase in speed and reduction in power consumption over other legacy architectures employing CPU and memory on different chips. The disadvantage of this arrangement, however, is that the physical spacing of the DRAM bit lines must be increased in order for the CPU cache bits to fit. Due to Design Rule constraints, cache bits are much larger than DRAM bits. As a result, the physical size of the DRAM connected to a CIM cache must be increased by as much as a factor of 4 compared to a DRAM not employing a CIM interdigitated cache of the present invention.

FIG. 6H demonstrates a more compact method of connecting CPU to DRAM in a CIMM. The steps necessary to select any bit of the DRAM to one bit of a plurality of caches are as follows:
1. Logically group memory bits into groups of 4 as indicated by address lines A[10:9].
2. Send all 4 bit lines from the DRAM to the Multiplexer input.
3. Select 1 of the 4 bit lines to the Multiplexer output by switching 1 of 4 switches controlled by the 4 possible states of address lines A[10:9].
4. Connect one of a plurality of caches to the Multiplexer output by using Demultiplexer switches. These switches are depicted in FIG. 6H as KX, KY, KS, KI, and KDMA. These switches and control signals are provided by instruction decoding logic.

The main advantage of an interdigitated cache embodiment of the CIMM Cache over the prior art is that a plurality of caches can be connected to almost any existing commodity DRAM array without modifying the array and without increasing the DRAM array's physical size.

### 3. Limited Sense Amp Drive

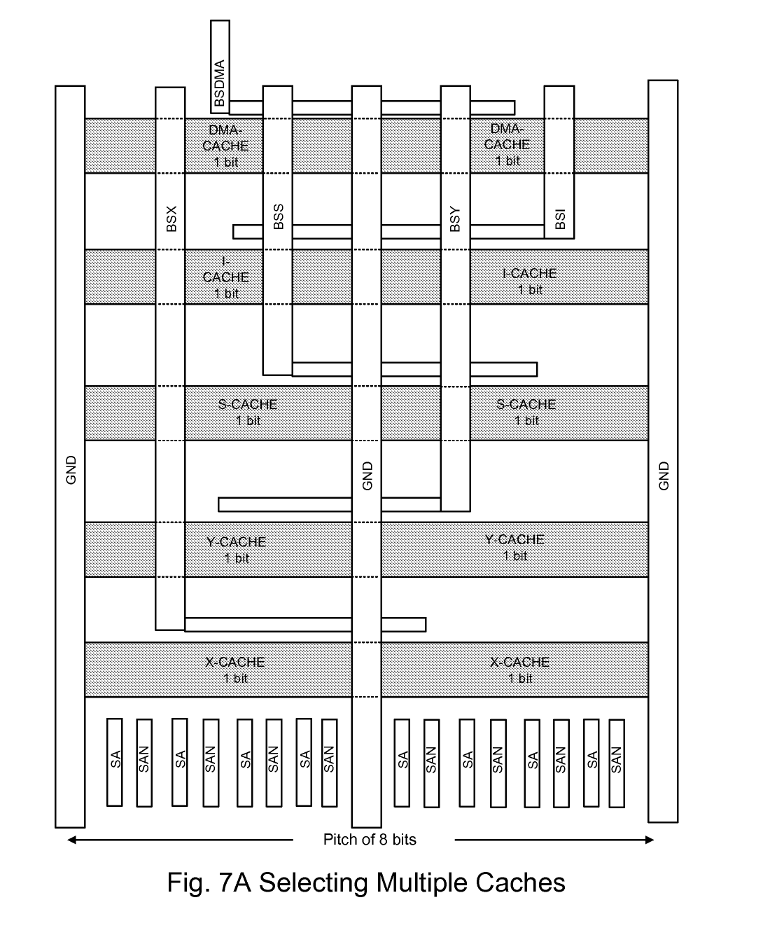

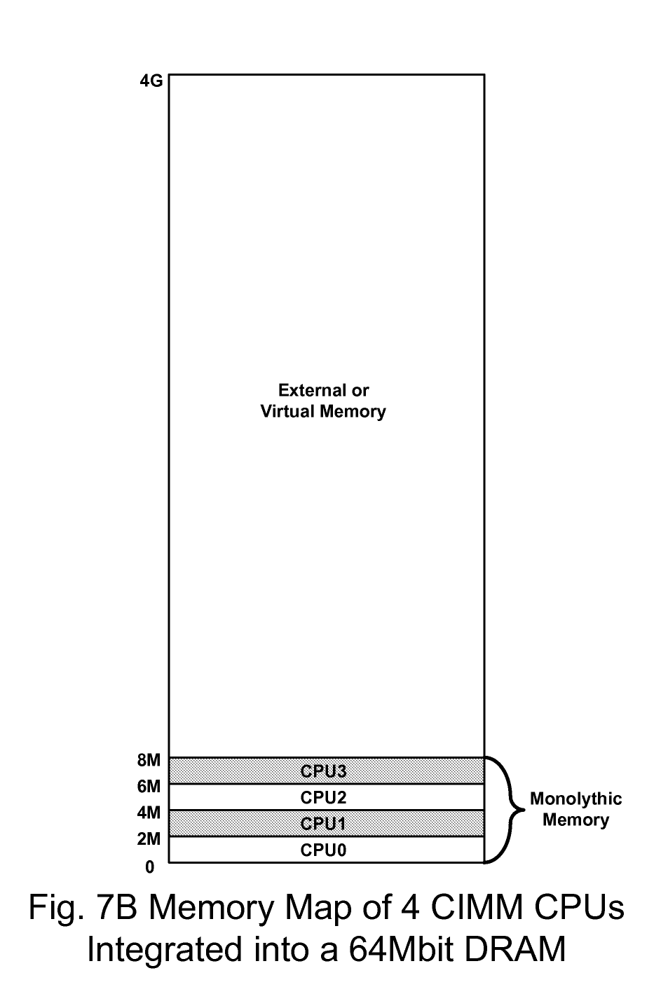

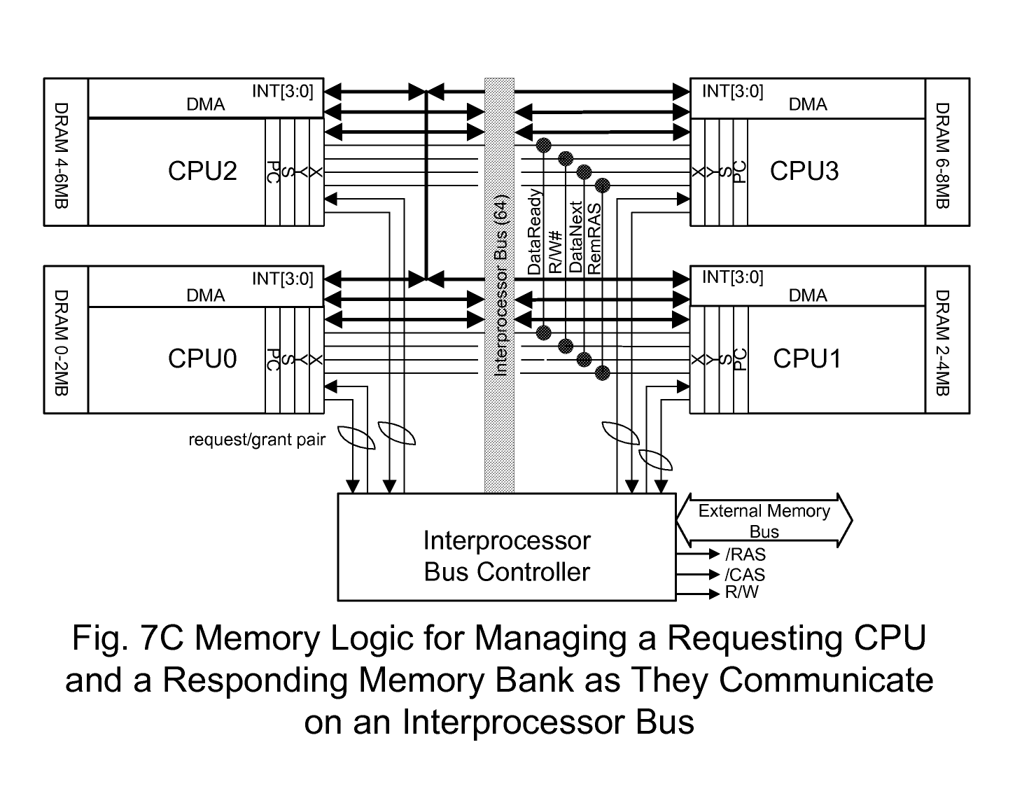

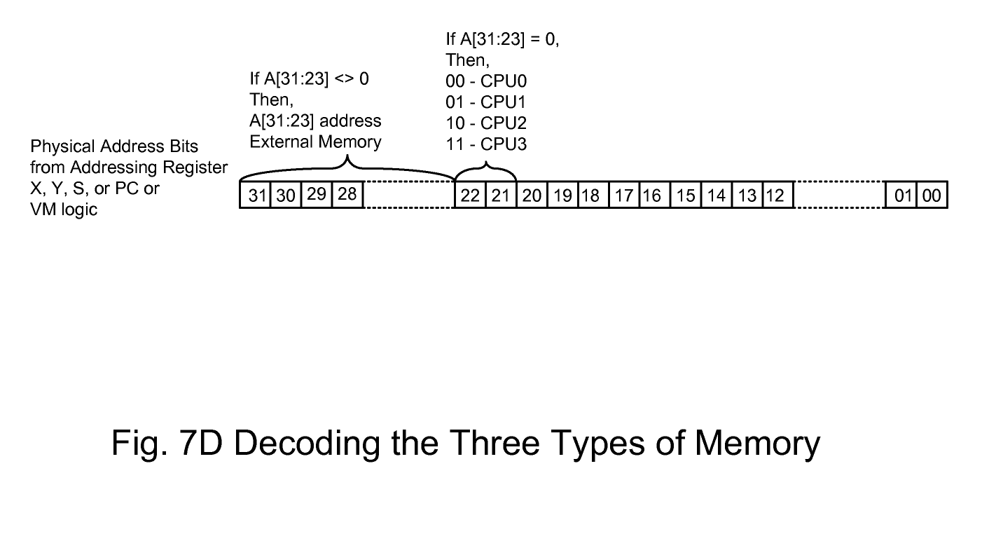

FIG. 7A shows a physically larger and more powerful embodiment of a bidirectional latch and bus driver. This logic is implemented using the larger transistors made with Peripheral Rules and covers the pitch of 4 bit lines. These larger transistors have the strength to drive the long data bus that runs along the edge of the memory array. The bidirectional latch is connected to 1 of the 4 cache bits by 1 of the pass transistors connected to Instruction Decode. For example, if an instruction directs the X-cache to be read, the Select X line enables the pass transistor that connects the X-cache to the bidirectional latch. FIG. 7A shows how the Decode and Repair Fuse blocks that are found in many memories can still be used with the invention.

### Managing Multiprocessor Caches and Memory

FIG. 7B shows a memory map of one contemplated embodiment of a CIMM Cache where 4 CIMM CPUs are integrated into a 64 Mbit DRAM. The 64 Mbits are further divided into four 2 Mbyte banks. Each CIMM CPU is physically placed adjacent to each of the four 2 Mbyte DRAM banks. Data passes between CPUs and memory banks on an interprocessor bus. An interprocessor bus controller arbitrates with request/grant logic such that one requesting CPU and one responding memory bank at a time communicate on the interprocessor bus.

FIG. 7C shows exemplary memory logic as each CIMM processor views the same global memory map. The memory hierarchy consists of:
Local Memory—2 Mbytes physically adjacent to each CIMM CPU;
Remote Memory—All monolithic memory that is not Local Memory (accessed over the interprocessor bus); and
External Memory—All memory that is not monolithic (accessed over the external memory bus).

Each CIMM processor in FIG. 7B accesses memory through a plurality of caches and associated addressing registers. The physical addresses obtained directly from an addressing register or from the VM manager are decoded to determine which type of memory access is required: local, remote or external. CPU0 in FIG. 7B addresses its Local Memory as 0-2 Mbytes. Addresses 2-8 Mbytes are accessed over the interprocessor bus. Addresses greater than 8 Mbytes are accessed over the external memory bus. CPU1 addresses its Local Memory as 2-4 Mbytes. Addresses 0-2 Mbytes and 4-8 Mbytes are accessed over the interprocessor bus. Addresses greater than 8 Mbytes are accessed over the external memory bus. CPU2 addresses its Local Memory as 4-6 Mbytes. Addresses 0-4 Mbytes and 6-8 Mbytes are accessed over the interprocessor bus. Addresses greater than 8 Mbytes are accessed over the external memory bus. CPU3 addresses its Local Memory as 6-8 Mbytes. Addresses 0-6 Mbytes are accessed over the interprocessor bus. Addresses greater than 8 Mbytes are accessed over the external memory bus.

Unlike legacy multi-core caches, CIMM Caches transparently perform interprocessor bus transfers when the address register logic detects the necessity. FIG. 7D shows how this decoding is performed. In this example, when the X register of CPU1 is changed explicitly by a STOREACC instruction or implicitly by a predecrement or postincrement instruction, the following steps occur:
1. If there was no change in bits A[31-23], do nothing. Otherwise,
2. If bits A[31-23] are not zero, transfer 512 bytes from external memory to X-cache using the external memory bus and the interprocessor bus.
3. If bits A[31:23] are zero, compare bits A[22:21] to the numbers indicating CPU1, 01 as seen in FIG. 7D. If there is a match, transfer 512 bytes from the local memory to the X-cache. If there is not a match, transfer 512 bytes from the remote memory bank indicated by A[22:21] to the X-cache using the interprocessor bus.
   The described method is easy to program, because any CPU can transparently access local, remote or external memory.

### VM Management by Cache Page “Misses”

Unlike legacy VM management, the CIMM Cache need look up a virtual address only when the most significant bits of an address register change. Therefore VM management implemented with CIMM Cache will be significantly more efficient and simplified as compared to legacy methods. FIG. 6A details one embodiment of a CIMM VM manager. The 32-entry CAM acts as a TLB. The 20-bit virtual address is translated to an 11-bit physical address of a CIMM DRAM row in this embodiment.

### Structure and Operation of the Least Frequently Used (LFU) Detector

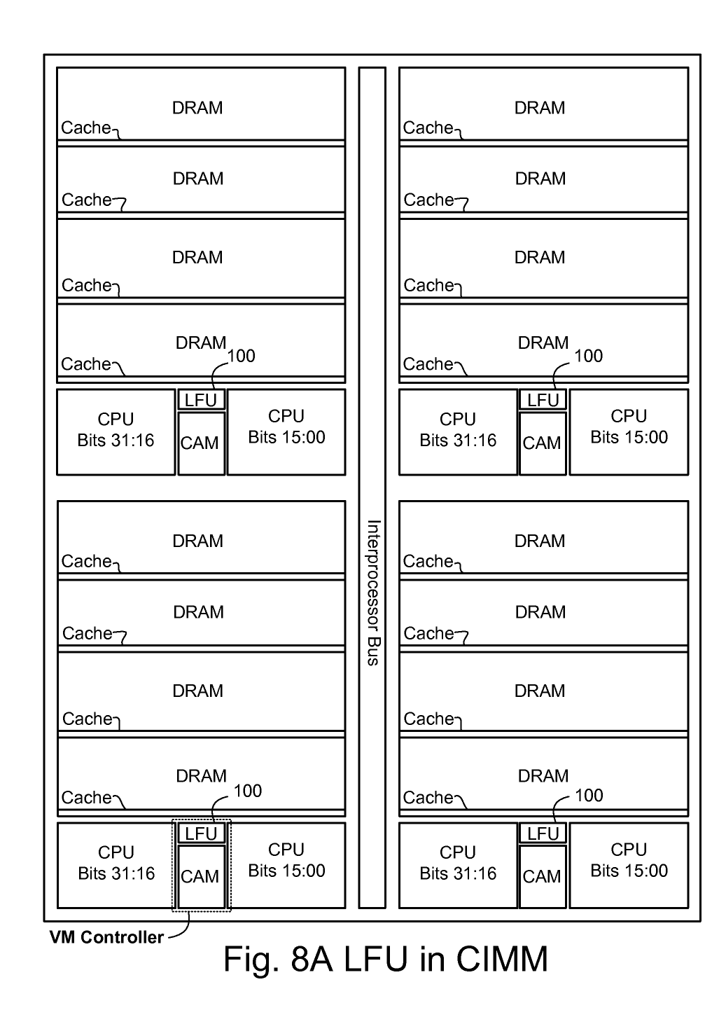

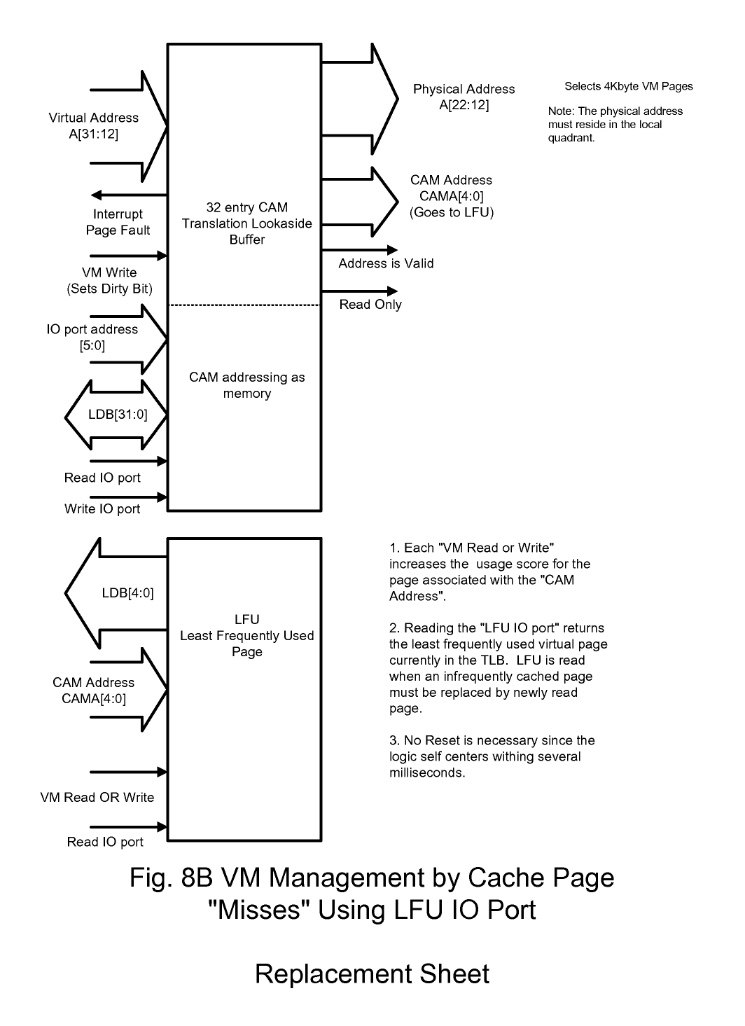

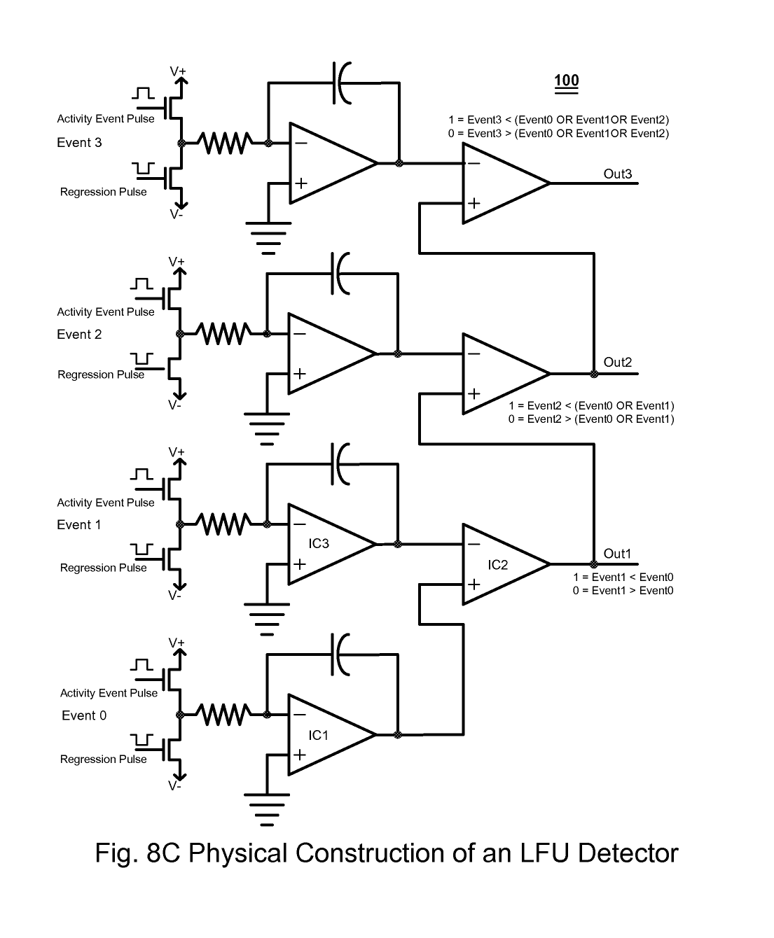

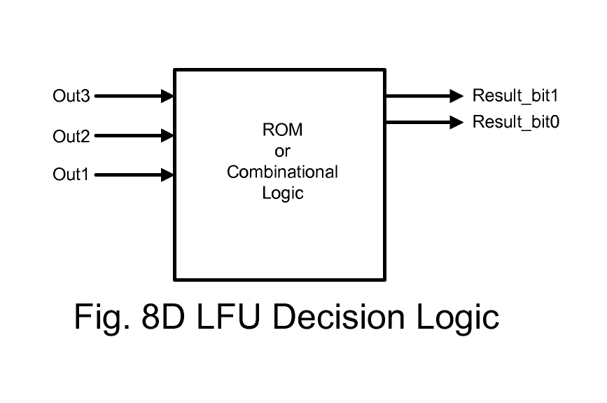

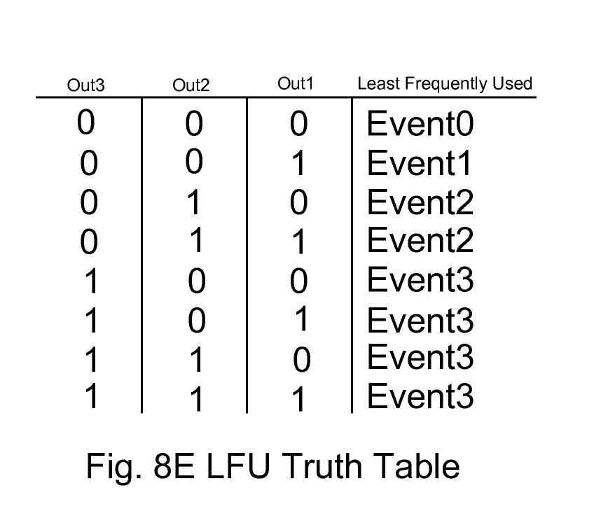

FIG. 8A depicts VM controllers that implement VM logic, identified by the term “VM controller” of one CIMM Cache embodiment which converts 4K-64K pages of addresses from a large imaginary “virtual address space” to a much smaller existing “physical address space”. The list of the virtual to physical address conversions is often accelerated by a cache of the conversion table often implemented as a CAM (See FIG. 6B). Since the CAM is fixed in size, VM manager logic must continuously decide which virtual to physical address conversions are least likely to be needed so it can replace them with new address mapping. Very often, the least likely to be needed address mapping is the same as the “Least Frequently Used” address mapping implemented by the LFU detector embodiment shown in FIGS. 8A-E of the present invention.

The LFU detector embodiment of FIG. 8C shows several “Activity Event Pulses” to be counted. For the LFU detector, an event input is connected to a combination of the memory Read and memory Write signals to access a particular virtual memory page. Each time the page is accessed the associated “Activity Event Pulse” attached to a particular integrator of FIG. 8C slightly increases the integrator voltage. From time to time all integrators receive a “Regression Pulse” that prevents the integrators from saturating.

Each entry in the CAM of FIG. 8B has an integrator and event logic to count virtual page reads and writes. The integrator with the lowest accumulated voltage is the one that has received the fewest event pulses and is therefore associated with the least frequently used virtual memory page. The number of the least frequently used page LDB[4:0] can be read by the CPU as an IO address. FIG. 8B shows operation of the VM manager connected to a CPU address bus A[31:12]. The virtual address is converted by the CAM to physical address A[22:12]. The entries in the CAM are addressed by the CPU as IO ports. If the virtual address was not found in the CAM, a Page Fault Interrupt is generated. The interrupt routine will determine the CAM address holding the least frequently used page LDB[4:0] by reading the IO address of the LFU detector. The routine will then locate the desired virtual memory page, usually from disk or flash storage, and read it into physical memory. The CPU will write the virtual to physical mapping of the new page to the CAM IO address previously read from the LFU detector, and then the integrator associated with that CAM address will be discharged to zero by a long Regression Pulse.

The TLB of FIG. 8B contains the 32 most likely memory pages to be accessed based on recent memory accesses. When the VM logic determines that a new page is likely to be accessed other than the 32 pages currently in the TLB, one of the TLB entries must be flagged for removal and replacement by the new page. There are two common strategies for determining which page should be removed: least recently used (LRU) and least frequently used (LFU). LRU is simpler to implement and is usually much faster than LFU. LRU is more common in legacy computers. However, LFU is often a better predictor than LRU. The CIMM Cache LFU methodology is seen beneath the 32 entry TLB in FIG. 8B. It indicates a subset of an analog embodiment of the CIMM LFU detector. The subset schematic shows four integrators. A system with a 32-entry TLB will contain 32 integrators, one integrator associated with each TLB entry. In operation, each memory access event to a TLB entry will contribute an “up” pulse to its associated integrator. At a fixed interval, all integrators receive a “down” pulse to keep the integrators from pinning to their maximum value over time. The resulting system consists of a plurality of integrators having output voltages corresponding to the number of respective accesses of their corresponding TLB entries. These voltages are passed to a set of comparators that compute a plurality of outputs seen as Out1, Out2, and Out3 in FIGS. 8C-E. FIG. 8D implements a truth table in a ROM or through combinational logic. In the subset example of 4 TLB entries, 2 bits are required to indicate the LFU TLB entry. In a 32 entry TLB, 5 bits are required. FIG. 8E shows the subset truth table for the three outputs and the LFU output for the corresponding TLB entry.

### Differential Signaling

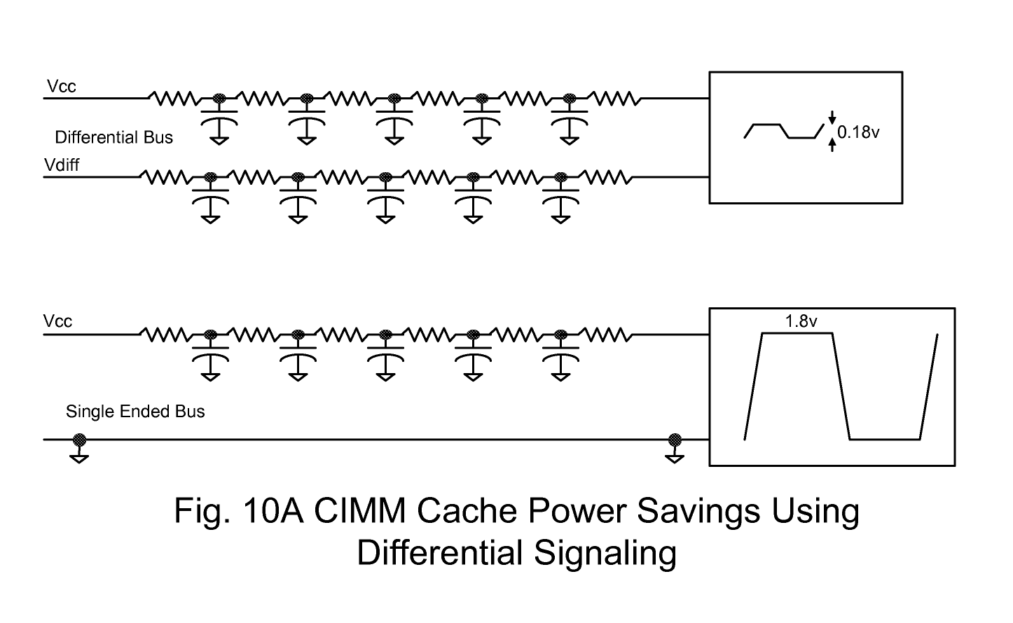

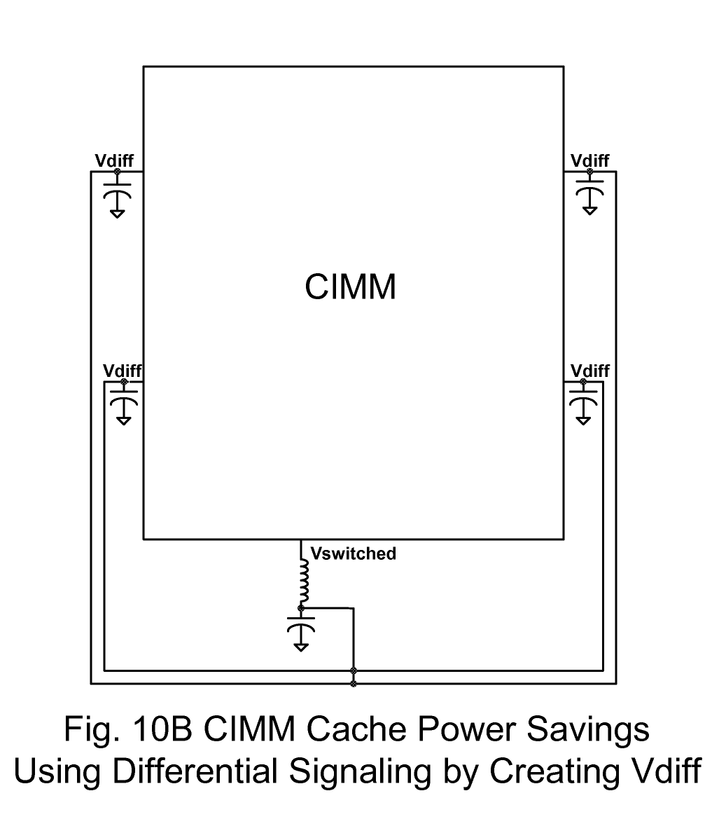

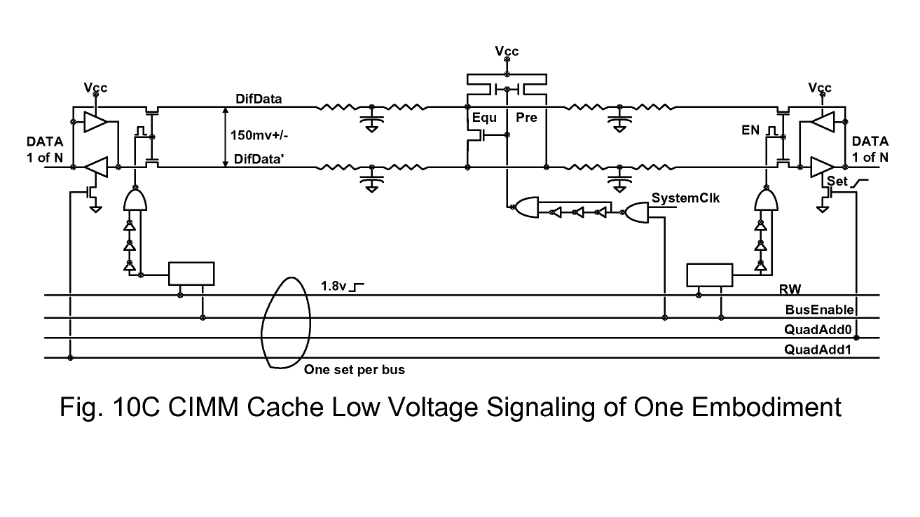

Unlike prior art systems, one CIMM Cache embodiment uses low voltage differential signaling (DS) data busses to reduce power consumption by exploiting their low voltage swings. A computer bus is the electrical equivalent of a distributed resistor and capacitor to ground network as shown in FIGS. 10A-B. Power is consumed by the bus in the charging and discharging of its' distributed capacitors. Power consumption is described by the following equation: frequency X capacitance X voltage squared. As frequency increases, more power is consumed, and likewise, as capacitance increases, power consumption increases as well. Most important however is the relationship to voltage. The power consumed increases as the square of the voltage. This means that if the voltage swing on a bus is reduced by 10, the power consumed by the bus is reduced by 100. CIMM Cache low voltage DS achieves both the high performance of differential mode and low power consumption achievable with low voltage signaling. FIG. 10C shows how this high performance and low power consumption is accomplished. Operation consists of three phases:

1. The differential busses are pre-charged to a known level and equalized;

2. A signal generator circuit creates a pulse that charges the differential busses to a voltage high enough to be reliably read by a differential receiver. Since the signal generator circuit is built on the same substrate as the busses it is controlling, the pulse duration will track the temperature and process of the substrate on which it is built. If the temperature increases, the receiver transistors will slow down, but so will the signal generator transistors. Therefore the pulse length will be increased due to the increased temperature. When the pulse is turned off, the bus capacitors will retain the differential charge for a long period of time relative to the data rate; and

3. Some time after the pulse is turned off, a clock will enable the cross coupled differential receiver. To reliably read the data, the differential voltage need only be higher than the mismatch of the voltage of the differential receiver transistors.

### Parallelizing Cache and Other CPU Operations

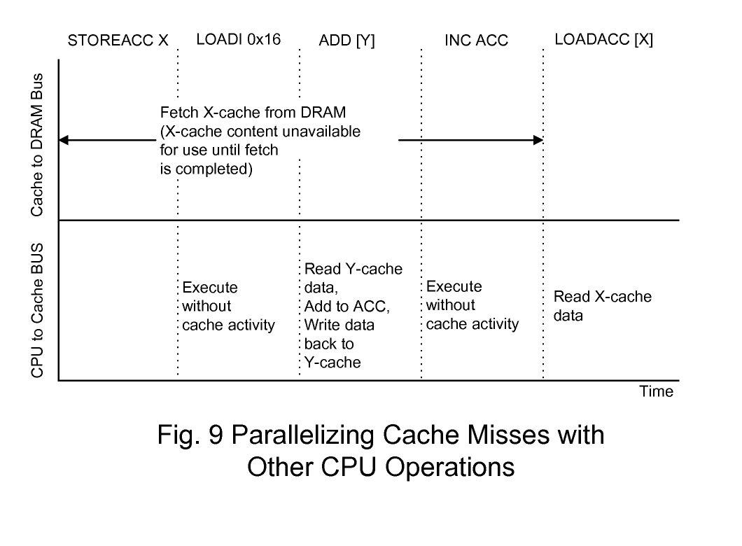

One CIMM Cache embodiment comprises 5 independent caches: X, Y, S, I (instruction or PC), and DMA. Each of these caches operates independently from the other caches and in parallel. For example, the X-cache can be loaded from DRAM, while the other caches are available for use. As shown in FIG. 9, a smart compiler can take advantage of this parallelism by initiating a load of the X-cache from DRAM while continuing to use an operand in the Y-cache. When the Y-cache data is consumed, the compiler can start a load of the next Y-cache data item from DRAM and continue operating on the data now present in the newly loaded X-cache. By exploiting overlapping multiple independent CIMM Caches in this way, a compiler can avoid cache “miss” penalties.

### Boot Loader

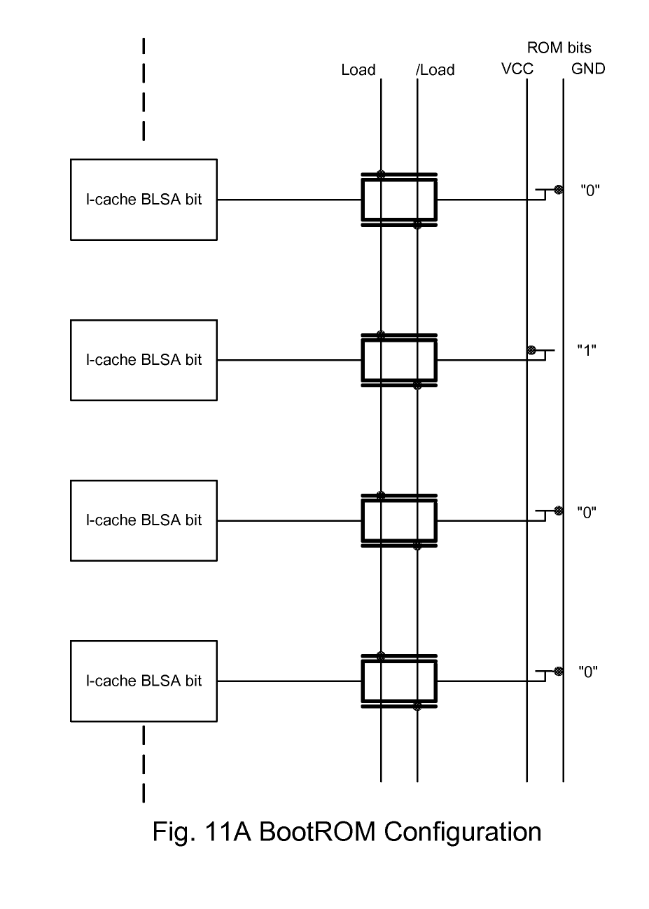

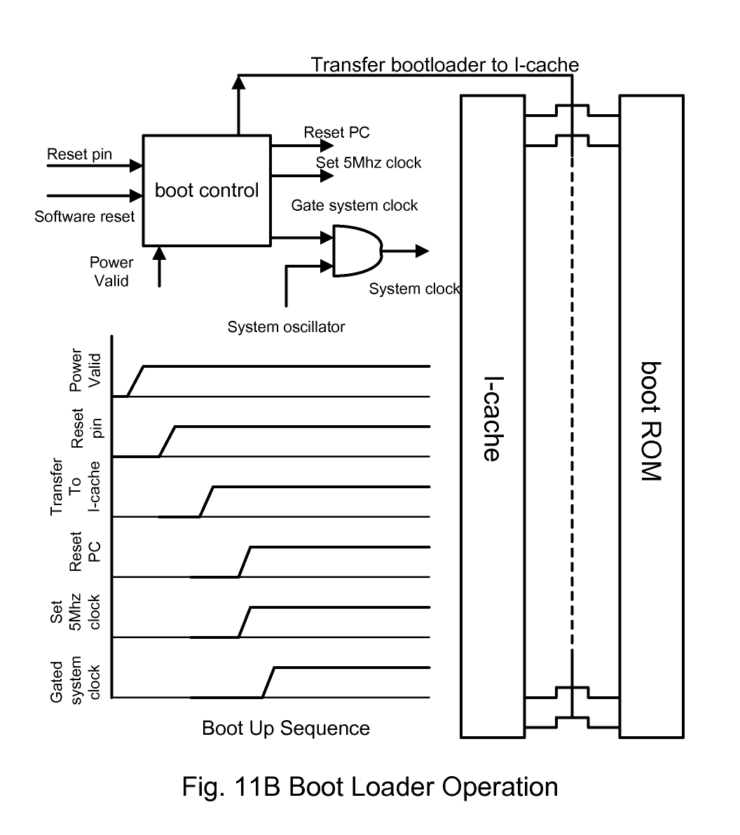

Another contemplated CIMM Cache embodiment uses a small Boot Loader to contain instructions that load programs from permanent storage such as Flash memory or other external storage. Some prior art designs have used an off-chip ROM to hold the Boot Loader. This requires the addition of data and address lines that are only used at startup and are idle for the rest of the time. Other prior art places a traditional ROM on the die with the CPU. The disadvantage of embedding ROM on a CPU die, is that a ROM is not very compatible with the floor plan of either an on-chip CPU or a DRAM. FIG. 11A shows a contemplated BootROM configuration, and FIG. 11B depicts an associated CIMM Cache Boot Loader Operation, respectively. A ROM that matches the pitch and size of the CIMM single line instruction cache is placed adjacent to the instruction cache (i.e. the I-cache in FIG. 11B). Following RESET, the contents of this ROM are transferred to the instruction cache in a single cycle. Execution therefore begins with the ROM contents. This method uses the existing instruction cache decoding and instruction fetching logic and therefore requires much less space than previously embedded ROMs.

The previously described embodiments of the present invention have many advantages as disclosed. Although various aspects of the invention have been described in considerable detail with reference to certain preferred embodiments, many alternative embodiments are likely. Therefore, the spirit and scope of the claims should not be limited to the description of the preferred embodiments, nor the alternative embodiments, presented herein. Many aspects contemplated by applicant's new CIMM Cache architecture such as the LFU detector, for example, can be implemented by legacy OSs and DBMSs, in legacy caches, or on non-CIMM chips, thus being capable of improving OS memory management, database and application program throughput, and overall computer execution performance through an improvement in hardware alone, transparent to the software tuning efforts of the user.

What is claimed is:

1. A cache architecture for a computer system having at least one processor, comprising a demultiplexer, and at least two local caches for each said processor, said local caches comprising an I-cache dedicated to an instruction addressing register and an X-cache dedicated to a source addressing register; wherein each said processor accesses at least one on-chip internal bus containing one RAM row for an associated said local cache; wherein said local caches are operable to be filled or flushed in one RAS cycle, and all sense amps of said RAM row can be deselected by said demultiplexer to a duplicate corresponding bit of the associated said local cache.

2. A cache architecture according to claim 1, said local caches further comprising a DMA-cache dedicated to at least one DMA channel.

3. A cache architecture according to claim 1 or 2, said local caches further comprising an S-cache dedicated to a stack work register.

4. A cache architecture according to claim 1 or 2, said local caches further comprising a Y-cache dedicated to a destination addressing register.

5. A cache architecture according to claim 1 or 2, said local caches further comprising an S-cache dedicated to a stack work register and a Y-cache dedicated to a destination addressing register.

6. A cache architecture according to claim 1 or 2, further comprising at least one LFU detector for each said processor comprising on-chip capacitors and operational amplifiers configured as a series of integrators and comparators which implement Boolean logic to continuously identify a least frequently used cache page through reading the IO address of the LFU associated with that cache page.

7. A cache architecture according to claim 1 or 2, further comprising a boot ROM paired with every said local cache to simplify CIM cache initialization during a reboot operation.

8. A cache architecture according to claim 1 or 2, further comprising a multiplexer for each said processor to select sense amps of said RAM row.

9. A cache architecture according to claim 3, further comprising a multiplexer for each said processor to select sense amps of said RAM row.

10. A cache architecture according to claim 4, further comprising a multiplexer for each said processor to select sense amps of said RAM row.

11. A cache architecture according to claim 5, further comprising a multiplexer for each said processor to select sense amps of said RAM row.

12. A cache architecture according to claim 6, further comprising a multiplexer for each said processor to select sense amps of said RAM row.

13. A cache architecture according to claim 7, further comprising a multiplexer for each said processor to select sense amps of said RAM row.

14. A cache architecture according to claim 1 or 2, wherein each said processor accesses said at least one on-chip internal bus using low voltage differential signaling.

15. A cache architecture according to claim 3, wherein each said processor accesses said at least one on-chip internal bus using low voltage differential signaling.

16. A cache architecture according to claim 4, wherein each said processor accesses said at least one on-chip internal bus using low voltage differential signaling.

17. A cache architecture according to claim 5, wherein each said processor accesses said at least one on-chip internal bus using low voltage differential signaling.

18. A cache architecture according to claim 6, wherein each said processor accesses said at least one on-chip internal bus using low voltage differential signaling.

19. A cache architecture according to claim 7, wherein each said processor accesses said at least one on-chip internal bus using low voltage differential signaling.

20. A cache architecture according to claim 8, wherein each said processor accesses said at least one on-chip internal bus using low voltage differential signaling.

21. A cache architecture according to claim 9, wherein each said processor accesses said at least one on-chip internal bus using low voltage differential signaling.

22. A cache architecture according to claim 10, wherein each said processor accesses said at least one on-chip internal bus using low voltage differential signaling.

23. A cache architecture according to claim 11, wherein each said processor accesses said at least one on-chip internal bus using low voltage differential signaling.

24. A cache architecture according to claim 12, wherein each said processor accesses said at least one on-chip internal bus using low voltage differential signaling.

25. A cache architecture according to claim 13, wherein each said processor accesses said at least one on-chip internal bus using low voltage differential signaling.

26. A method of connecting a processor within the RAM of a monolithic memory chip, comprising the steps necessary to allow selection of any bit of said RAM to a duplicate bit maintained in a plurality of caches, the steps comprising:
(a) logically grouping memory bits into groups of four;
(b) sending all four bit lines from said RAM to a multiplexer input;
(c) selecting one of the four bit lines to the multiplexer output by switching one of four switches controlled by four possible states of address lines;
(d) connecting one of said plurality of caches to the multiplexer output by using demultiplexer switches provided by instruction decoding logic.

27. A method for managing virtual memory (VM) of a CPU through cache page misses, comprising the steps of:
(a) while said CPU processes at least one dedicated cache addressing register, said CPU inspects the contents of said register's high order bits; and
(b) when the contents of said bits change, said CPU returns a page fault interrupt to a VM manager to replace the contents of said cache page with a new page of VM corresponding to the page address contents of said register, if the page address contents of said register is not found in a CAM TLB associated with said CPU; otherwise
(c) said CPU determines a real address using said CAM TLB.

28. The method of claim 27, further comprising the step of
(d) determining the least frequently cached page currently in said CAM TLB to receive the contents of said new page of VM, if the page address contents of said register is not found in a CAM TLB associated with said CPU.

29. The method of claim 28, further comprising the step of
(e) recording a page access in an LFU detector; said step of determining further comprising determining the least frequently cached page currently in the CAM TLB using said LFU detector.

30. A method to parallelize cache misses with other CPU operations, comprising the steps of:
(a) until cache miss processing for a first cache is resolved, processing the contents of at least a second cache if no cache miss occurs while accessing the second cache; and
(b) processing the contents of the first cache.

31. A method of reducing power consumption in digital buses on a monolithic chip, comprising the steps of:
(a) equalizing and pre-charging a set of differential bits on at least one bus driver of said digital buses;
(b) equalizing a receiver;
(c) maintaining said bits on said at least one bus driver for at least the slowest device propagation delay time of said digital buses;
(d) turning off said at least one bus driver;
(e) turning on the receiver; and
(f) reading said bits by the receiver.

32. A method to lower power consumed by cache buses, comprising the following steps:
(a) equalize pairs of differential signals and pre-charge said signals to Vcc;
(b) pre-charge and equalize a differential receiver;
(c) connect a transmitter to at least one differential signal line of at least one cross-coupled inverter and discharge it for a period of time exceeding the cross-coupled inverter device propagation delay time;
(d) connect the differential receiver to said at least one differential signal line; and
(e) enable the differential receiver allowing said at least one cross-coupled inverter to reach full Vcc swing while biased by said at least one differential line.

33. A method of booting CPU in memory architecture using a bootload linear ROM, comprising the following steps:
(a) detect a Power Valid condition by said bootload ROM;
(b) hold all CPUs in Reset condition with execution halted;
(c) transfer said bootload ROM contents to at least one cache of a first CPU;
(d) set a register dedicated to said at least one cache of said first CPU to binary zeroes; and
(e) enable a System clock of said first CPU to begin executing from said at least one cache.

34. The method of claim 33, wherein said at least one cache is an instruction cache.

35. The method of claim 34, wherein said register is an instruction register.

36. A method for decoding local memory, virtual memory and off-chip external memory by a CIM VM manager, comprising the steps of:
(a) while a CPU processes at least one dedicated cache addressing register, if said CPU determines that at least one high order bit of said register has changed; then
(b) when the contents of said at least one high order bit is nonzero, said VM manager transfers a page addressed by said register from said external memory to said cache using an external memory bus; otherwise
(c) said VM manager transfers said page from said local memory to said cache.

37. The method of claim 36, wherein said at least one high order bit of said register only changes during processing of a STORACC instruction to any addressing register, a pre-decrement instruction, and a post-increment instruction, said CPU determines step further comprising determination by instruction type.

38. A method for decoding local memory, virtual memory and off-chip external memory by a CIMM VM manager, comprising the steps of:
(a) while a CPU processes at least one dedicated cache addressing register, if said CPU determines that at least one high order bit of said register has changed; then
(b) when the contents of said at least one high order bit is nonzero, said VM manager transfers a page addressed by said register from said external memory to said cache using an external memory bus and an interprocessor bus; otherwise
(c) if said CPU detects that said register is not associated with said cache, said VM manager transfers said page from a remote memory bank to said cache using said interprocessor bus; otherwise
(d) said VM manager transfers said page from said local memory to said cache.

39. The method of claim 38. wherein said at least one high order bit of said register only changes during processing of a STORACC instruction to any addressing register, a pre-decrement instruction, and a post-increment instruction, said CPU determines step further comprising determination by instruction type.
